(19) United States
(12) Patent Application Publication
(10) Pub. No.: US 2017/0244978 A1
(43) Pub. Date: Aug. 24, 2017

(54) IMAGE PROCESSING DEVICE AND IMAGE PROCESSING METHOD PERFORMING SELECTIVE IMAGE ENCRYPTION

(71) Applicants: BYUNG-TAK LEE, YONGIN-SI (KR); JI-WOONG KWON, SEOUL (KR)

(72) Inventors: BYUNG-TAK LEE, YONGIN-SI (KR); JI-WOONG KWON, SEOUL (KR)

(21) Appl. No.: 15/165,695

(22) Filed: May 26, 2016

(30) Foreign Application Priority Data
Sep. 15, 2015 (KR) 10-2015-0130615

(51) Int. Cl. H04N 19/467; H04N 19/167; H04N 19/70; H04N 19/107

(52) U.S. Cl. CPC H04N 19/467; H04N 19/107; H04N 19/167; H04N 19/70; H04N 19/176

(57) ABSTRACT

An image processing device and an image processing method performing selective image encryption are provided. The image processing method includes compressing an image including a plurality of areas, selectively encrypting some of the plurality of areas, generating encryption information indicating which of the plurality of areas are encrypted, and transmitting an encrypted image and the encryption information.

### CROSS-REFERENCE TO RELATED APPLICATION

This application claims the benefit of Korean Patent Application No. 10-2015-0130615, filed on Sep. 15, 2015 in the Korean Intellectual Property Office, the disclosure of which is hereby incorporated by reference in its entirety.

### BACKGROUND

The inventive concept relates to image processing systems, devices and methods. More particularly, the inventive concept relates to image processing devices and systems that utilize an image processing method that performs selective image encryption.

Generally, an image processing device improves image transmission efficiency by transmitting the image after performing some form of image compression. Examples of image compression include inter prediction that compresses an image, or image area, with reference to another image or image area, as well as intra compression that compresses an image, or image area, without reference to another image area.

Encryption is often performed on a compressed image that may be exported outside the image processing system in order to provide image data security. Encryption can require a considerable time and expenditure of system resources. And as required image resolution increases, more device or system resources are consumed. This may lead to deterioration of system performance.

### SUMMARY

The inventive concept provides an image processing device and an image processing method that may efficiently encrypt a compressed image or image area.

According to an aspect of the inventive concept, there is provided an image processing method including compressing an image including a plurality of areas, selectively encrypting some of the plurality of areas, generating encryption information indicating which of the plurality of areas are encrypted, and transmitting an encrypted image and the encryption information.

According to another aspect of the inventive concept, there is provided an image processing method including compressing an image including a plurality of areas, determining at least one of a compression characteristic and an image characteristic of each of the plurality of areas, selecting some of the plurality of areas as an encryption area, based on the determination, and transmitting an encrypted image and encryption information with respect to each of the plurality of areas.

According to another aspect of the inventive concept, there is provided an image processing method including selectively encrypting a first area of a frame image, transmitting a first packet, the first packet including an encrypted image of the first area and encryption information having a first value indicating that the first area is encrypted, and transmitting a second packet, the second packet including a non-encrypted image of a second area of the frame image and encryption information having a second value indicating that the second area is not encrypted.

According to another aspect of the inventive concept, there is provided an image processing device including a compression unit compressing an image including a plurality of areas, an encryption unit selectively encrypting some of the plurality of areas, and an interface host transmitting an encrypted image on which a compression operation and a selective encryption operation have been performed and encryption information indicating which of the plurality of areas are encrypted.

According to another aspect of the inventive concept, there is provided a universal serial bus (USB) TV system including a USB device configured to receive encoded data via a USB protocol, an image processing device configured to process the encoded data received via the USB device, and at least one port configured to output an original image generated via the image processing device, according to at least one interface, wherein an encrypted image included in the encoded data is an image in which only some of a plurality of areas are selectively encrypted, and the image processing device selectively decrypts the plurality of areas of the encrypted image, by referring to at least one piece of information included in the encoded data.

According to another aspect of the inventive concept, there is provided a system including an encoder that generates a compressed image. The encoder includes an encryption unit that includes a compression unit that receives an image including a plurality of areas including a first area and a second area and generates a compressed image, the compression unit includes an intra compressor that compresses the first area without reference to another one of the plurality of areas and an inter compressor that compresses the second area with reference to at least another one of the plurality of areas, as well as an encryption unit that receives the compressed image, and generates an encrypted image and corresponding encryption information, wherein the encryption unit selectively designates at least a portion of the first area as an encryption area within the encrypted image and selectively designates the second area as a non-encryption area within the encrypted area.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of an image processing system according to an exemplary embodiment;

FIG. 2 is a block diagram of an embodiment of an encoder according to an exemplary embodiment;

FIG. 3 is a block diagram of an embodiment of an encryption unit of FIG. 2;

FIG. 4 is a block diagram of an embodiment of a decoder according to an exemplary embodiment;

FIGS. 5, 6, 7, 8 and 9 are views of examples in which an encryption area is selected in a frame image, according to exemplary embodiments;

FIGS. 10 and 11 are views of an example of header information that is generated, according to an exemplary embodiment;

FIGS. 12 and 13 are flowcharts of image processing methods according to exemplary embodiments;

FIG. 14 is a block diagram of an encryption unit included in an encoder according to exemplary embodiments;

FIGS. 15A, 15B, and 15C are views of types of frames in an image compression process;

FIG. 16 is a view of an example in which only some areas of a frame image, selected as an encryption area are encrypted;

FIG. 17 is a flowchart of an image processing method of an encoder including the encryption unit of FIG. 14;

FIG. 18 is a block diagram of an encryption unit included in an encoder according to exemplary embodiments;

FIG. 19 is a view of an example in which an encryption area is selected in a frame image;

FIG. 20 is a block diagram of an encryption unit included in an encoder according to exemplary embodiments;

FIGS. 21 and 22 are views of examples in which an encryption area is selected in a frame image;

FIG. 23 is a flowchart of an image processing method of an encoder including the encryption units of FIGS. 18 and 20;

FIG. 24 is a block diagram of an embodiment of a decryption unit included in a decoder according to an exemplary embodiment;

FIG. 25 is a block diagram of a computing system including an image processing device according to an exemplary embodiment;

FIG. 26 is a block diagram of an example of an interface used in the computing system of FIG. 25; and

FIG. 27 is a block diagram of an example of a universal serial bus (USB) TV system in which an image processing method is applied, according to exemplary embodiments;

### DETAILED DESCRIPTION OF THE EMBODIMENTS

Embodiments of the inventive concept will now be described in some additional detail with reference to the accompanying drawings. These embodiment are provided so that this disclosure is thorough and complete and fully conveys the scope of the inventive concept to one of ordinary skilled in the art. The inventive concept may be embodied in many different forms, and should not be construed as being limited to the embodiments set forth herein.

Embodiment according to the inventive concept may be modified in various ways and take on various alternative forms, and thus, specific embodiments thereof are shown in the drawings and described in detail below as examples. However, there is no intent to limit the inventive concept to the particular forms disclosed. On the contrary, the inventive concept is to cover all modifications, equivalents, and alternatives falling within the spirit and scope of the appended claims.

It will be understood that when an element, such as a layer, a region, or a substrate, is referred to as being “on,” “connected to” or “coupled to” another element, it may be directly on, connected or coupled to the other element or intervening elements may be present.

On the other hand, it will be understood that when an element, such as a layer, a region, or a substrate, is referred to as being “directly on,” “directly connected to” or “directly coupled to” another element, intervening elements are not present. Other expressions, such as, “between” and “directly between”, describing the relationship between the constituent elements, may be construed in the same manner.

The terminology used herein is for the purpose of describing particular embodiments only and is not intended to be limiting of the inventive concept. As used herein, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless explicitly so defined herein. As used herein, the term “and/or” includes any and all combinations of one or more of the associated listed items. Expressions such as “at least one of,” when preceding a list of elements, modify the entire list of elements and do not modify the individual elements of the list.

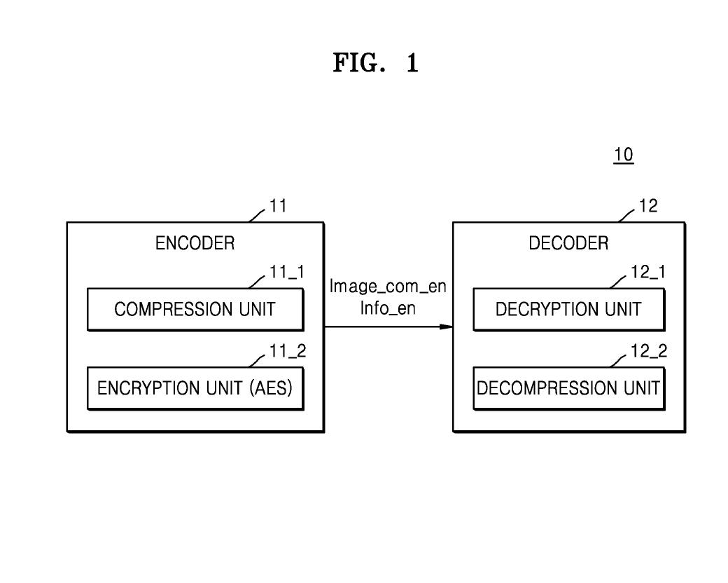

Figure (FIG. 1 is a block diagram of an image processing system 10 according to an exemplary embodiment. As illustrated in FIG. 1, the image processing system 10 may include an encoder 11 and a decoder 12. Each of the encoder 11 and the decoder 12 may correspond to an image processing device.

According to an exemplary embodiment, the encoder 11 may include a compression unit 11_1 and an encryption unit 11_2. The compression unit 11_1 may be used to compress data associated with an image in order to generate a compressed image. In this regard, the compression unit 11_1 may perform data compression using inter prediction and/or intra prediction. The encryption unit 11_2 then receives the compressed image from the compression unit 11_1, and may selectively encrypt the compressed image wholly or in part to generate an encrypted image (or an encoded image). By compressing the image, the bandwidth required to subsequently communicate the constituent image data within the encoder 11, as well as communicate the image data externally, is decreased and the power required to communicate the image data may be reduced. When the image data is externally communicated from the encoder 11, the security of the communicated image data may be enhanced by use of an encryption operation. Hence, the encryption unit 11_2 may encrypt the compressed image provided from the compression unit 11_1 using various approaches that may be respectively implemented in hardware and/or software.

For example, the encryption unit 11_2 may perform an encryption operation using the advanced encryption standard (AES) algorithm. As a result, an encrypted image (Image_com_en) generated by encrypting the compressed image, as described above, may be provided by the encoder 11.

Here, the operation of the compression unit 11_1 and/or encryption unit 11_2 may be generally controlled by a video encoding processor, a central processor, a graphics processor, etc. (not shown) provided internal to or external from the encoder 11.

The compression unit 11_1 may compress the image based on various image standards, such as MPEG-2, H.264/AVC, VP8, HEVC, etc. For example, the compression unit 11_1 may receive an image according to a defined frame unit. Hereafter, an image or image portion communicated according to a defined frame unit will be called “a frame image.” Hence, certain embodiments may be said to perform a compression operation on a received frame image. According to this approach, the compression unit 11_1 may receive a sequence of frame images, and perform the compression operation on each of the received plurality of frame images.

Recognizing that the compression operation described above may be based on inter prediction and intra prediction for exemplary embodiments, the concept of inter prediction and intra prediction may be defined by various approaches.

For example, inter prediction and intra prediction may be defined based on a plurality of frames. According to inter prediction, a current frame image may be compressed with reference to at least one other frame. For example, a motion estimation with respect to a predetermined unit (e.g., a block unit) of the current frame image may be performed, and a difference value between a pixel value for a block and a pixel value for a prediction block of the current frame image may be provided as a compression result. In contrast, according to intra prediction, a frame image may be compressed by using a pixel value calculated within the frame image without reference to another frame.

According to an exemplary embodiment, inter prediction and intra prediction may be defined within a compression operation with respect to a frame image. Here, the frame image may include a plurality of areas, and in the case of the inter prediction, any selected area may be compressed with reference to a pixel value calculated for at least one area adjacent to the area (i.e., at least one adjacent area). However, in the case of intra prediction, a selected area may be compressed by using a pixel value calculated for the selected area without reference to any other area.

Frame image areas may be variously defined using different methods. For example, a frame image may be defined as including a plurality of lines, and constituent frame image areas may be respectively defined as units including a single line from among the plurality of lines. Alternatively, a frame image area may be defined as including two or more lines from among the plurality of lines. In another alternative, the frame image may be divided into a plurality of packets, wherein the plurality of packets are defined in a manner conducive to the eventual transmission of image data. Using this alternative, a frame image area may be defined as including one or more packets. In yet another alternative, a frame image may include a plurality of blocks, wherein the plurality of blocks are defined in a manner that supports a prediction operation. Using this alternative, a frame image area may be defined as including one or more blocks. Thus, it will be understood by those skilled in the art that frame image areas are susceptible to various definitions and may be defined in various sizes in view of the particular compression operation applied to the frame image.

Further with respect to the compression operation, a frame that is compressed without reference to another frame from among the plurality of frames may be referred to as an intra-frame, while a frame compressed with reference to another frame may be referred to as an inter-frame. Also, an area compressed without reference to another area in a frame image may be referred to as an intra-coded-area, while an area compressed with reference to one or more other area(s) in the frame image may be referred to as an inter-coded-area. According to an exemplary embodiment, the process of selecting an encryption area (i.e., an area selected for encryption) with respect to a compressed frame image may be based on a “compression characteristic” of the frame image. For example, an encryption area selection may be performed on the basis of an intra frame, an inter frame, an intra-coded-area, an inter-coded-area, etc.

Thus, in one example, the encryption unit 11_2 may determine whether each area is an intra-coded-area or an inter-coded-area, and thereafter selectively encrypt certain areas according to the results of the determination. In one possible approach, the encryption unit 11_2 may perform encryption of a selected area if the selected area is determined to be an intra-coded-area. In contrast, the encryption unit 11_2 may not perform encryption of a selected area if the selected area is determined to be an inter-coded-area. This approach has implications to the overall image data security issue. That is, if an intra-coded-area is not decrypted, pixel values (e.g., for the original data) included in the intra-coded-area may not be obtained, and thus, pixels of an associated inter-coded-area that is compressed with reference to the intra-coded-area may not be obtained as well. As a result, if encryption is selectively performed with respect to only certain frame image areas, the security of the overall frame image including the selectively encrypted areas will be affected.

As another example, the encryption unit 11_2 may selectively encrypt all intra-coded-areas while also encrypting only certain inter-coded-areas. In still another example, for any given intra-coded-area, encryption may be performed on only some pixels selected from a plurality of pixels in the intra-coded-area. Common to the foregoing examples, the encryption unit 11_2 does not encrypt the total frame image, but instead selectively encrypts only certain areas of the frame image. As a result, the amount of data that requires encryption may be reduced, and the overall efficiency of the encryption operation improved.

According to another exemplary embodiment, a selective encryption of a frame image, or area(s) of a frame image, may be performed on the basis of whether or not data is compressed. For example, with respect to certain (first selected) pixels of a frame image, the compression unit 11_1 may determine to simply provide original data—without compressing the received data. Yet, other (second selected) pixels of the frame image may be compressed with reference to the first selected pixels—that is, with respect to the first selected pixels (or original data). In this context, the terms “first selected” and “second selected” do not refer to only active selections. Rather, one group of first selected pixels or second selected pixels may be defined by non-selection during the selection of another group. Hence, first and second selections merely distinguish different handling of respective pixels.

In this manner, the encryption unit 11_2 may selectively perform an encryption operation with respect to first selected pixels (e.g., an area of original data), whereby the corresponding first selected pixel data (or original data) is essentially passed through as the result of the compression operation. However, the encryption unit 11_2 may not perform encryption with respect to second selected pixels (e.g., an area of compressed data), whereby the corresponding second selected pixel data (or compressed data) is provided. Extending this exemplary embodiment, some of the second selected pixels (e.g., a portion of the compressed data) may be selectively designated as an encryption area within the group (e.g., a frame image area) otherwise selected for non-encryption.

Consistent with the foregoing, the encoder 11 may provide not only the encrypted image (Image_com_en), but also encryption information (Info_en) associated with the encryption operation to the decoder 12. Here, for example, the encryption information may include information indicating whether or not each frame image area is encrypted.

In certain exemplary embodiments, the encoder 11 may include an interface unit (e.g., a high-speed interface (HSI) host) facilitating communication of the encrypted image and related encryption information to the decoder 12. The interface unit may operate according to one or more data communication protocols. For example, the interface unit may operate using one or more protocols that defines certain header information (or packet header information) including the encryption information.

With reference again to FIG. 1, the decoder 12 includes a decryption unit 12_1 and a decompression unit 12_2. The decoder 12 generally performs a decryption operation with respect to encrypted data, following which the decoder 12 performs a decompression operation with respect to the decrypted data. These are effectively the reverse of the operations performed by the encoder 11. Thus, in this manner, the decoder 12 may extract the encryption information (Info_en) from received header information, and thereafter selectively perform decryption using the decryption unit 12_1 on respective, encrypted portions of the encrypted data (i.e., the encrypted image) received from the encoder 11. Such portions of encrypted data may correspond to selected frame image areas, portions of frame image areas, and/or selected pixels, and may be indicated using the extracted encryption information. Then, the decompression unit 12_2 may be used to generate original data by performing a decompression operation on the resulting decrypted data.

According to the above-described exemplary embodiments, since only some areas of an image may be encrypted, the amount of data necessarily encrypted may be decreased, security of an externally communicated encrypted image may be enhanced, and image data transmission efficiency may be improved.

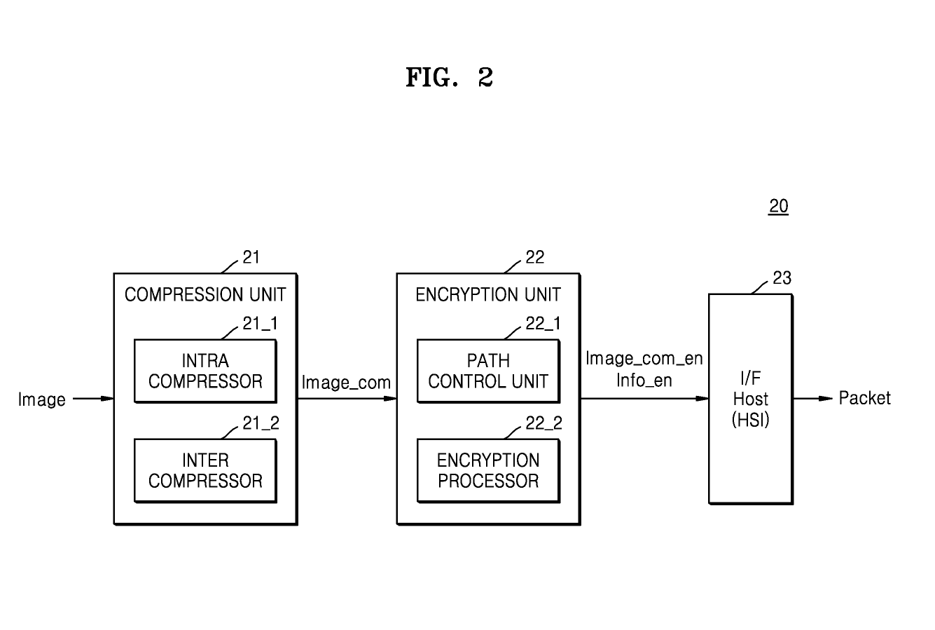

FIG. 2 is a block diagram further illustrating in one embodiment 20 the encoder 11 of FIG. 1 according to an exemplary embodiment.

The encoder 20 may include a compression unit 21, an encryption unit 22, and an interface host 23. The compression unit 21 may include an intra compressor 21_1 and an inter compressor 21_2. The encryption unit 22 may include a path control unit 22_1 and an encryption processor 22_2, and the interface host 23 may include various types of interfaces supporting communication of at least an encrypted image and corresponding encryption information. In certain exemplary embodiments, the interface host 23 may be an HSI host.

The compression unit 21 may perform a compression operation on an image (e.g., data associated with an original image) provided to the encoder 20. The compression operation may be performed according to an intra method or an inter method, and with respect to a frame unit, as described above. The intra compressor 21_1 compresses a current frame without reference to another frame, whereas the inter compressor 21_2 compresses a current frame with reference to at least one other frame.

The encryption unit 22 may be used to generate a compressed and encrypted image (e.g., an encrypted image, (Image_com_en)) by performing an encryption operation on a compressed image (Image_com) provided by the compression unit 21, as described above. For example, in order to selectively encrypt only some frame image areas, the path control unit 22_1 may select (or identify) a data transmission path for each frame image area. If a first frame image area is an encryption image, for example, the path control unit 22_1 may provide data from the first area to the encryption processor 22_2. However, if the first area is not an encryption area, the path control unit 22_1 may cause the data from the first area to bypass the encryption processor 222_2, such that the first area data is not encrypted.

The interface host 23 may then be used generate one or more packet(s) (hereafter, “the packet”) including the encrypted image (Image_com_en) as well as corresponding encryption information (Info_en). The packet may be variously defined as a unit including the encrypted image of predetermined size, header information corresponding to the encrypted image that may include the encryption information.

The encryption information may be generated by the encryption unit 22 during the image data encryption process, and may thereafter be provided to the interface host 23. According to certain exemplary embodiments, the compression and encryption operations may be controlled by a central processing device (not shown) included in the encoder 20 running competent control software. The encryption information may be generated while the central processing device executes the control software.

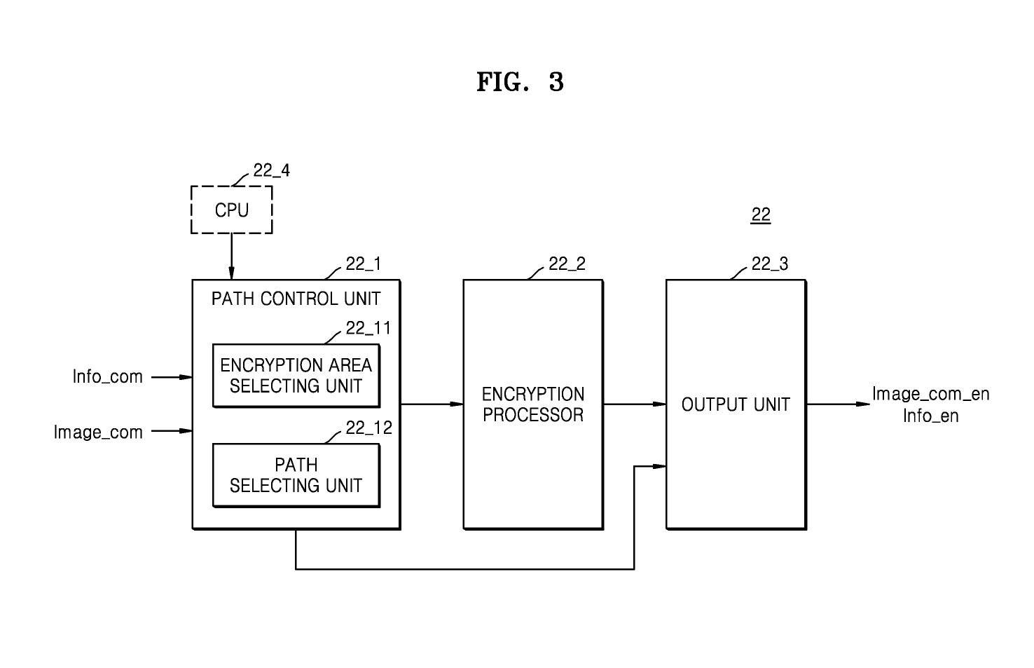

FIG. 3 is a block diagram further illustrating in one embodiment the encryption unit 22 of FIG. 2.

Referring to FIGS. 2 and 3, the encryption unit 22 may include the path control unit 22_1 and encryption processor 22_2, as well as an output unit 22_3, where the path control unit 22_1 may include an encryption area selecting unit 22_11 and a path selecting unit 22_12.

The path control unit 22_1 may selectively provide a compressed image (Image_com) generated by compressing a frame image to the encryption processor 22_2 on an area by area basis. The encryption area selecting unit 22_11 may select an encryption area based on a compression method with respect to each of a plurality of areas included in the frame image. For example, the encryption area selecting unit 22_11 may select an encrypted area (or alternately termed “an encryption area”—i.e., an area having its constituent data encrypted) of the frame image using compression information (Info_com) provided by the compression unit 21. Here, the compression information may be generated and provided to the path control unit 22_1 by the compression unit 21, or it may be generated under the control of a central processing unit (CPU) 22_4 controlling the operation of the encoder 11 wholly or in part. Since the CPU 22_4 may be disposed internal to or external from the encoder 11 it is illustrated in FIG. 3 using dotted lines. A similar configuration of CPU may be used in various embodiments of the decoder 12.

In this regard, the encryption area selecting unit 22_11 may select a current frame image as the encryption area, when the current frame image corresponds to an intra frame as indicated by the compression information (Info_com). Alternately, the encryption area selecting unit 22_11 may select an intra-coded-area corresponding to some areas of the current frame image, as the encryption area, as indicated by the compression information (Info_com).

The path selecting unit 22_12 may control a transmission path for the compressed image (Image_com) in response to the result of the selection of the encryption area selecting unit 22_11. For example, the path selecting unit 22_12 may provide data for an encrypted area to the encryption processor 22_2. However, the path selecting unit 22_12 may directly provide data for a non-encrypted area to the output unit 22_3. The output unit 22_3 may output the resulting encrypted image (Image_com_en), as selectively encrypted on an area by area basis. According to an exemplary embodiment, the encryption unit 22 may further output the encryption information (Info_en).

As suggested previously, the encryption unit 22 may encrypt some inter-coded-areas, in addition to the intra-coded-areas. Here, the encryption area selecting unit 22_11 may further select some inter-coded-areas as the encrypted areas under the control of a central processing device (not shown).

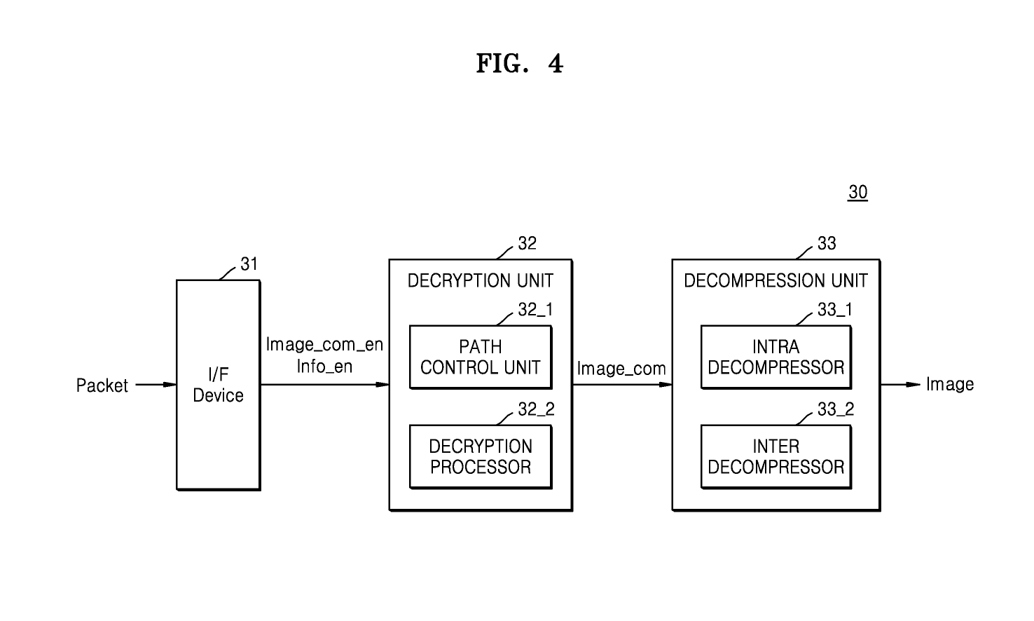

FIG. 4 is a block diagram further illustrating in one embodiment 30 the decoder 12 of FIG. 1.

With reference to FIGS. 1 and 4, the decoder 30 may include an interface device 31, a decryption unit 32, and a decompression unit 33. The decryption unit 32 may include a path control unit 32_1 and a decryption processor 32_2, and the decompression unit 33 may include an intra decompressor 33_1 and an inter decompressor 33_2.

The interface device 31 may serve as an interface with the encoder 11 and may operate according to one or more data communication protocols compatible with the one or more protocols used by the encoder 11. Here, it is assumed that the encoder 11 has generated a packet using a predetermined protocol. The packet may include the encrypted image (Image_com_en) and corresponding encryption information (Info_en) associated with the particular encryption approach used by the encoder 11. Thus, the interface device 31 may extract the encrypted image and corresponding encryption information from the received packet.

The decryption unit 32 may be used to identify encrypted areas in response to the extracted encryption information (Info_en), and may then selectively perform decryption on each encrypted area. For example, the path control unit 32_1 may provide data from certain frame image areas (i.e., encrypted and compressed image data) to the decryption processor 32_2 in response to the encryption information. Additionally, the path control unit 32_1 may cause data from other frame image areas (non-encrypted and compressed image data) to bypass the decompression unit 33. In this manner, the decryption unit 32 may generate (or re-generate) compressed image data (Image_com) by selectively performing a decryption operation corresponding to an encryption operation used by the encoder 11.

Accordingly, the decompression unit 33 receives compressed image data (Image_com) and by performing a decompression operation using the intra decompressor 33_1 and/or inter decompressor 33_2 generates the original image (Image). The intra decompressor 33_1 may generate portions of the original image without reference to another frame, and the inter decompressor 33_2 may generate other portions of the original image with reference to at least one other frame.

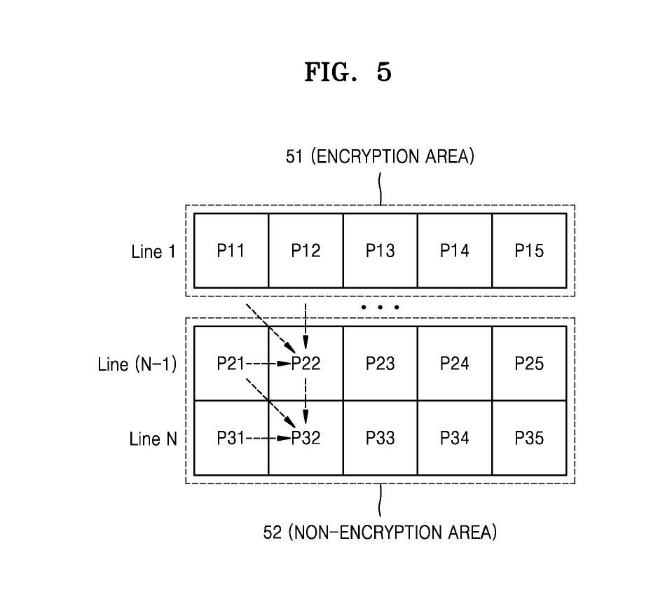

FIGS. 5, 6, 7, 8 and 9 are respective conceptual diagram illustrating examples of an encryption area and a non-encryption area selected from a frame image according to exemplary embodiments.

Referring to FIG. 5, an exemplary frame image is assumed to include a plurality of lines (e.g., Line 1 through Line N), wherein each one of the plurality of lines includes a plurality of pixels. For example, pixels P11 to P15 are included in the first line (Line 1), pixels P21 to P25 are included in the N−1^{th} line (Line N−1), and pixels P31 to P35 are included in the N^{th} line (Line N).

With respect to intra compression, the compression operation may be performed using a correlation among the pixels in the frame image. For example, a pixel value for any one of the pixels may be predicted by referring to a pixel value of at least another adjacent or proximate pixel. Adjacent pixels located in the same line (and/or in adjacent lines) may be referenced in certain exemplary embodiments.

As illustrated in FIG. 5, the pixels P11 to P15 included in Line 1 may be compressed without reference to other pixels in other lines. Thus, pixels P11 to P15 included in Line 1 may be compressed with reference to only other pixels included in the same line. However, the pixels in the other lines (e.g., Line N−1 and Line N) may be compressed by referencing pixels in at least one previous line (e.g., a superordinate line). Using this approach, the pixels of a second line (not shown in FIG. 5) may be compressed by using pixels P11 to P15 included in Line 1, pixels P31 to P35 included in Line N may be compressed by using pixels P21 to P25 included in Line (N−1), etc.

According to an exemplary embodiment, the pixels of Line 1 may correspond to an intra-coded-area 51 in the frame image, and pixels of the other lines (Lines N−1 and Line N) may correspond to an inter-coded-area 52. Resulting encryption area(s) may be selected in the frame image in view of a particular compression method used. For example, when the intra-coded-area 51 is selected as the encryption area, pixels of the intra-coded-area 51 may be encrypted and provided external to the system. However, pixels in the inter-coded-area 52 may be externally provided without being encrypted. Since pixels P11 to P15 in Line 1 are encrypted, pixel values for pixels in the other lines may not be readily obtained outside of the system since the pixel values for pixels P11 to P15 in Line 1 are not decoded.

According to another exemplary embodiment, with respect to Line 1, a compression result may be provided without reference to another line. For example, pixels P11 to P15 in Line 1 may not be compressed and the original data may be provided as a compression result. The original data of Line 1, provided as the compression result, may be selected as the encryption area. That is, according to an exemplary embodiment, the intra-coded-area may be defined as an area, the original data of which is provided as the compression result, without additionally being compressed.

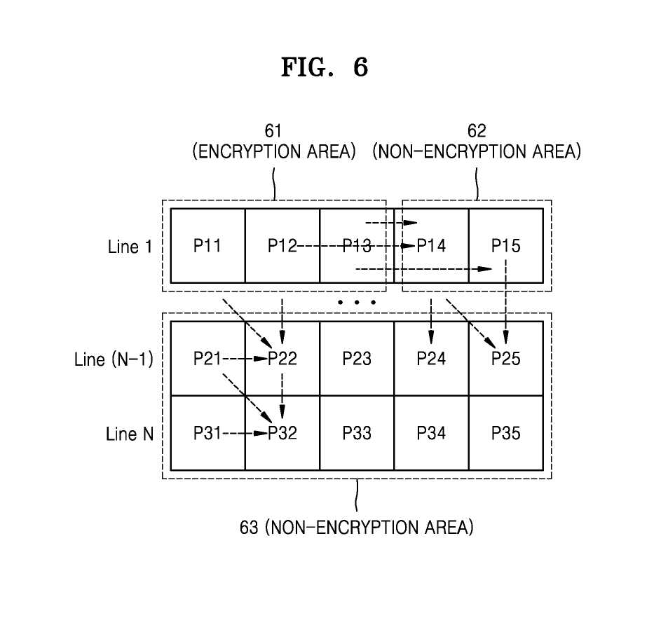

Referring now to FIG. 6, similar to the exemplary embodiment of FIG. 5, the frame image is assumed to again include Line 1 to Line N as described above, where Line 1 is assumed to be intra-coded-areas 61 and 62, and other lines (Line N−1 and Line N) are assumed to be an inter-coded-area 63. Accordingly, pixels P11 to P15 of Line 1 may be compressed by referring to only adjacent pixels in the same line, and original data of pixels P11 to P15 may be provided as a compression result.

For example, with respect to first selected pixels (e.g., P11, P12 and P13) of Line 1, original data may be provided as a compression result, whereas second selected pixels P14 and P15 may be compressed by referring to other pixels in Line 1. In this manner, the intra-coded-areas 61 and 62 may include a first selected (or original) area 61 and a second selected (or compression) area 62.

According to an exemplary embodiment, only certain pixels of a line may be selectively encrypted. For example, only the first selected pixels P11, P12 and P13 of the original area 61 of Line 1 may be selected as an encryption area, and the second selected pixels P14 and P15 may be selected as a compression area 62, and not encrypted. Also, as described in the above exemplary embodiment, the pixels of the inter-coded-area 63 are not encrypted.

Since pixels P11, P12 and P13 of the original area 61 of Line 1 are encrypted, if the first selected pixels P11, P12 and P13 are not decrypted, the pixel values of the other pixels P14 to P15 of Line 1 may not be identified. Also, pixel values for pixels of a second and subsequent lines (not shown in FIG. 6) compressed with reference to the pixels P11. P12 and P13 of Line 1 may not be identified.

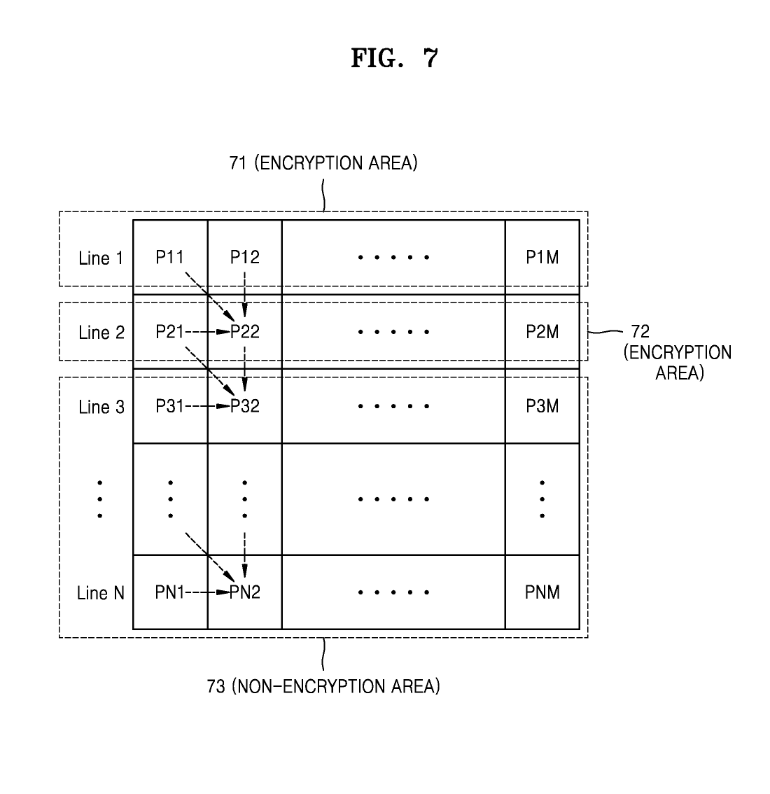

In FIG. 7, a frame image is again assumed to include a plurality of lines (Line 1 to Line N). It is assumed that pixels P11 to P1M are included in a first line (Line 1), pixels P21 to P2M are included in a second line (Line 2), and pixels PN1 to PNM are included in an Nth line (Line N). Line 1 is an intra-coded-area 71, original data of which is provided as a compression result, or an area that is compressed without referring to the pixels of the other lines, while the other lines correspond to inter-coded-areas 72 and 73 that are compressed by referring to pixels of at least one previous line.

According to the embodiment illustrated in FIG. 7, at least two lines included in the intra-coded-area 71 may be selected as an encryption area. For example, the intra-coded-area 71 may be selected as the encryption area, and the inter-coded-area 72 may further be selected as the encryption area. Thus, in certain embodiments of the inventive concept, certain lines among a plurality of lines constituting a frame image may be selectively encrypted, regardless of their status as an inter-coded-area.

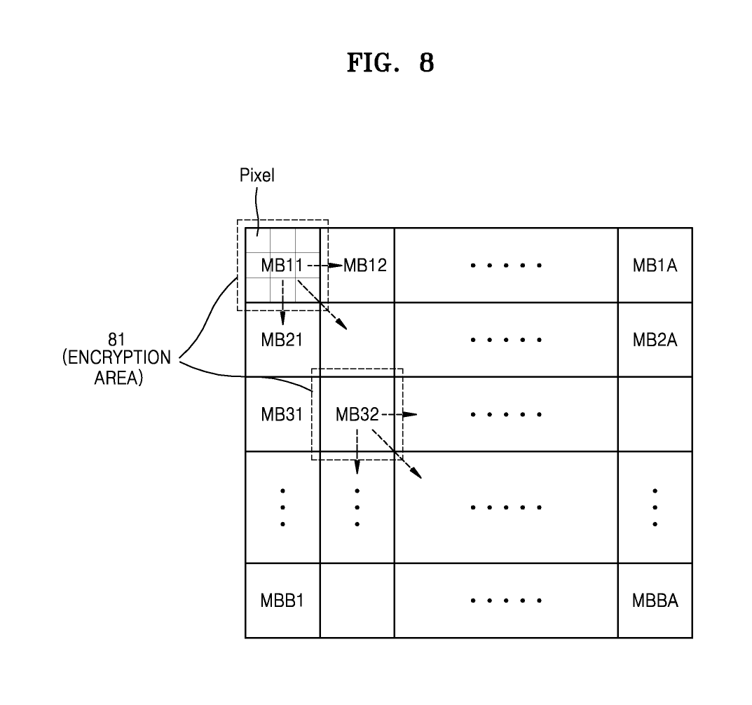

FIG. 8 illustrates a frame image including a plurality of areas. For example, one frame image may include a plurality of macro-blocks (MB), as a predetermined processing unit (e.g., a prediction unit). Thus, the frame image of FIG. 8 may include ‘A’ macro-blocks in a horizontal direction, and ‘B’ macro-blocks in a vertical direction, where each macro-block may include a plurality of pixels arranged in the horizontal and vertical directions (i.e., in a two-dimensional matrix).

Some of the macro-blocks may correspond to an intra-coded-area that is compressed without referring to other macro-blocks, and others of the macro-blocks may correspond to an inter-coded-area that is compressed by referring to adjacent macro-blocks. When it is assumed that the macro-blocks MB11 and MB32 from among the macro-blocks correspond to the intra-coded-area, the macro-blocks MB11 and MB32 of the intra-coded-area may be selected as the encryption area.

Similar to the foregoing embodiments, the encryption area may be selected using various methods based on the intra-coded-area and the inter-coded-area of the frame image. For example, the macro-blocks MB11 and MB32 corresponding to the intra-coded-area of the frame image, and at least one macro-block included in the inter-coded-area may together be selected as the encryption area. Alternatively, the macro-block MB11 corresponding to the intra-coded-area and other macro-blocks (for example, MB12 to MB1A) located in the same line may together be selected as the encryption area.

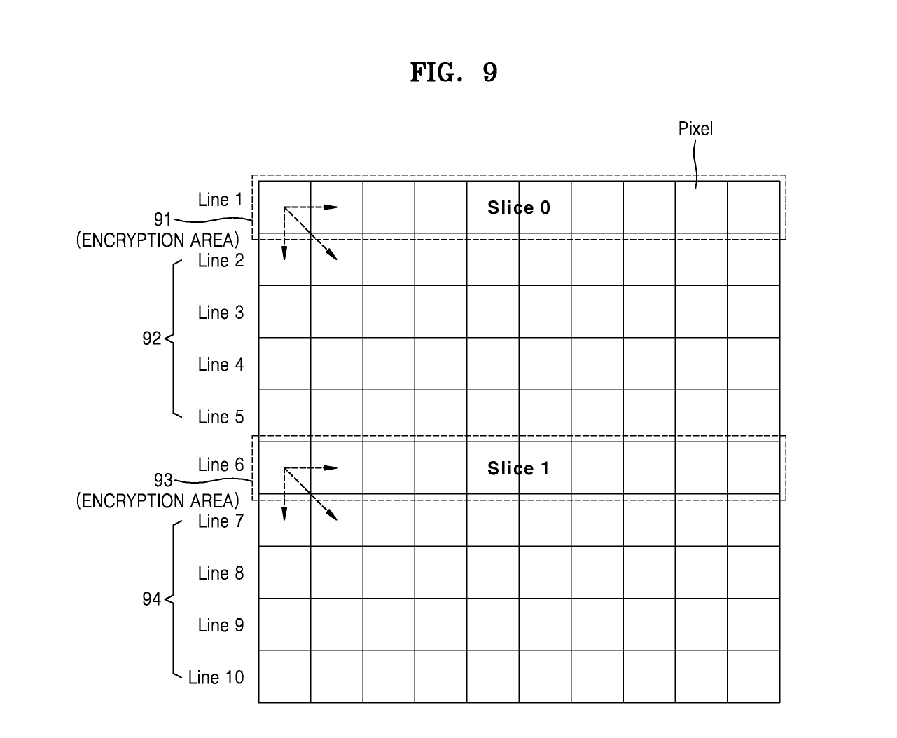

In FIG. 9, the frame image may be divided into areas of a predetermined size with reference, for example, to a compression operation. Thus, the frame image may include a plurality of slices. Here, the frame image includes two slices Slice 0 and Slice 1. Each of the slices may include a plurality of lines. For convenience of explanation, each slice is assumed to include five lines. However, other exemplary embodiment may include a frame image including any reasonable number of slices, where each slice area may include a plurality of lines.

The compression operation for the frame image may be performed on a slice by slice basis. For example, the compression operation of the image may be performed on each slice. Accordingly, pixels included in any one slice may be compressed by referring to only the pixels included in the same slice.

Thus, for the example of FIG. 9, Line 1 of Slice 0 may be an intra-coded-area 91, and may be compressed without referring to other lines. Line 2 through Line 5 of Slice 0 may be an inter-coded-area 92, and may be compressed by referring to other lines of Slice 0. Line 6 of Slice 1 may be an intra-coded-area 93, and may be compressed without referring to other lines. Line 7 to Line 10 of Slice 1 may be an inter-coded-area 94, and may be compressed by referring to other lines of Slice 1.

The encryption area may be selected based on compression characteristic(s). For example, the intra-coded-areas 91 and 93 of Slice 0 and Slice 1 may be selected as encryption area(s).

Similarly to the above-described embodiments, the encryption area may be selected using various methods. For example, referring to Slice 0, some lines of the inter-coded-area 92, in addition to the intra-coded-area 91, may further be selected as an encryption area. Alternatively, only some pixels of Line 1 corresponding to the intra-coded-area 91 may be selected as an encryption area.

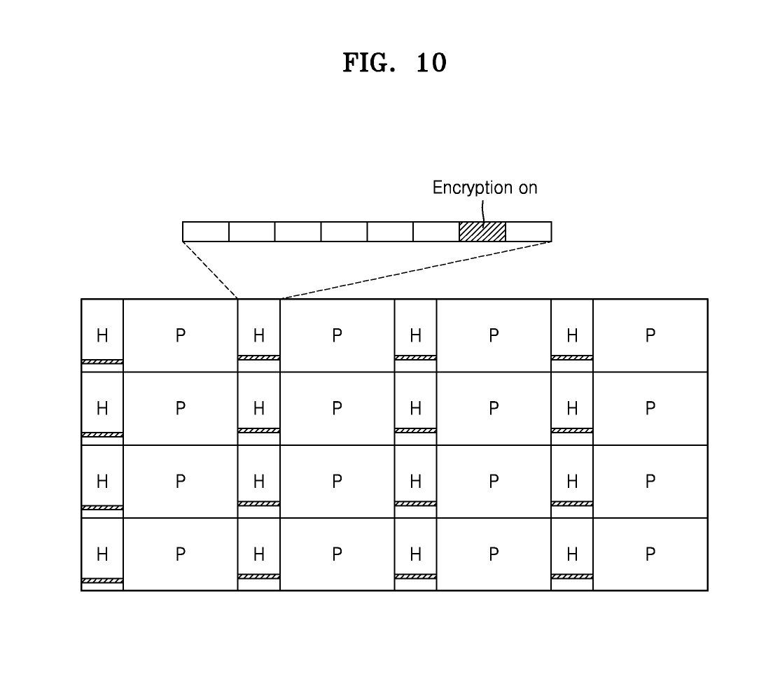

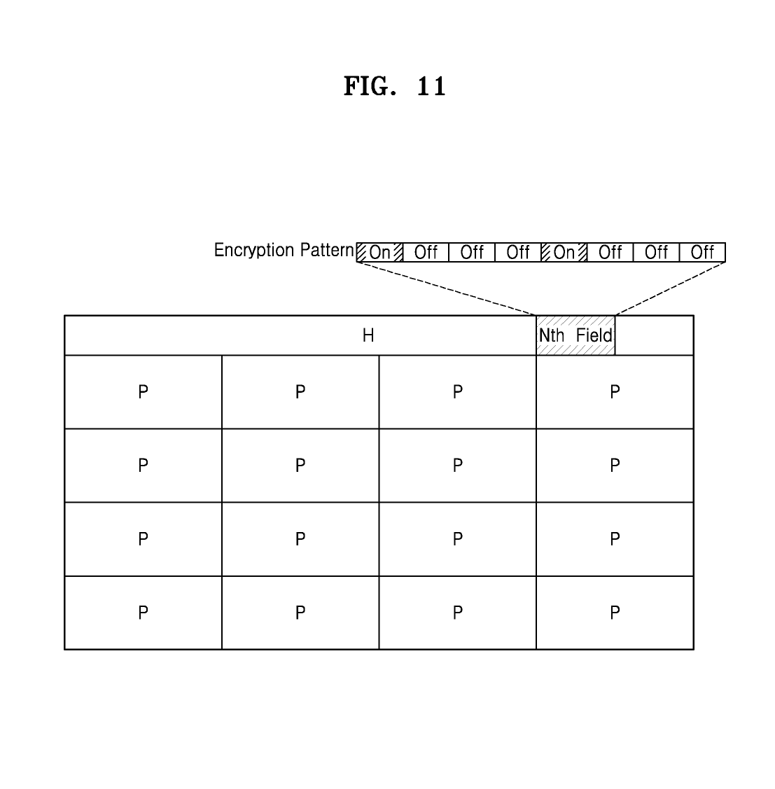

FIGS. 10 and 11 are conceptual diagram illustrating possible structures for header information generated according to an exemplary embodiment.

Referring to FIGS. 10 and 11, an encoder is again assumed to generate and transmit a packet including an encrypted image of a packet unit P, and header information H corresponding to the encrypted image. A frame image may include a plurality of packet units P. Each packet unit P may be defined by various methods. For example, the packet unit P may include some pixels of any one line. Alternatively, the packet unit P may be a unit including one line, or a unit including two or more lines. Alternatively, the packet unit P may be a unit including one macro-block, or may be a unit including two or more macro-blocks. Alternatively, the packet unit P may be defined as other forms than the described areas.

Referring to FIG. 10, the encoder may generate the header information H corresponding to each packet unit P, and the header information H may include a plurality of fields to include various information related to encoding. At least one of the plurality of fields may correspond to an encryption field indicating whether an image of the packet unit P is encrypted or not.

For example, a decoder may perform a decoding operation in the packet unit P. The decoding operation may include a decryption operation and a decompression operation with respect to an image of the packet unit P. A value of the encryption field may be extracted from the header information H included in each packet, and when the encryption field value corresponds to a first value, both the decryption operation and the decompression operation are performed with respect to the image of the corresponding packet unit P. However, when the encryption field value corresponds to a second value, the decryption operation may be skipped and only the decompression operation may be performed, with respect to the image of the corresponding packet unit P.

Referring to FIG. 11, the encoder may generate the header information H, in correspondence to a plurality of packet units P. That is, the header information H may include a plurality of fields, and any one field may correspond to an encryption field. Also, each field may have a pattern including information related to the plurality of packet units P. In the example of FIG. 11, the encryption field may have a pattern indicating whether each of the plurality of packet units P is encrypted or not.

The packet transmitted by the encoder may include an encrypted image or the header information H. Alternatively, the packet transmitted by the encoder may include both the encrypted image and the header information H. The decoder may extract a pattern of the encryption field from the header information H included in the packet, and may perform decryption or may not perform decryption with respect to an image of each of the plurality of packet units P according to the pattern of the encryption field.

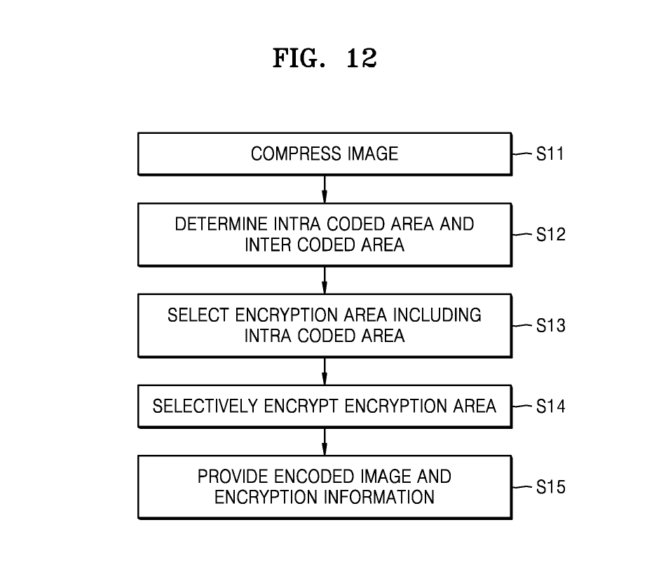

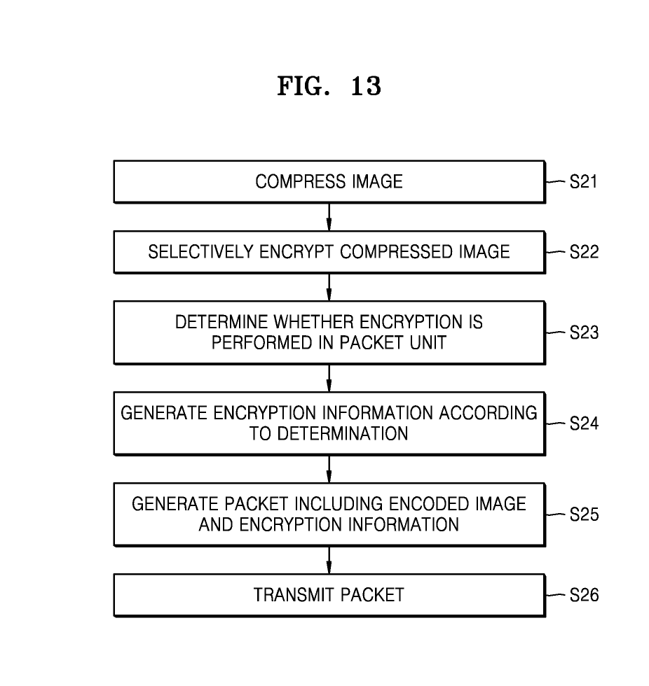

FIGS. 12 and 13 are flowcharts summarizing respective image processing methods according to exemplary embodiments.

The method of FIG. 12, consistent with the above-described exemplary embodiments, assumes that an image may be compressed using the intra and inter methods (S11). For example, in the frame image including a plurality of areas, with respect to some pixels, original data may be provided as a compression result, other pixels may be compressed without referring to pixels of other areas, and yet other pixels may be compressed by referring to pixels included in other areas. According to a result of the compression, with respect to some pixels in the frame image, the compression result may be provided as the original data, and with respect to other pixels, the compression result may be provided as prediction data by referring to data of adjacent pixels. According to the compression characteristic, the frame image may be divided into an intra-coded-area and an inter-coded-area, and the intra-coded-area may include the pixels, the original data of which is provided as the compression result, and the pixels that are compressed without referring to the pixels in other areas.

When encryption is performed on the frame image, the encryption may be selectively performed on only some areas of the frame image. For example, intra-coded-area(s) and inter-coded-area(s) may be determined in the frame image (S12), and an encryption area including at least the intra-coded-area may be selected (S13). For example, the encryption area may include only the pixels included in the intra-coded-area, or the encryption area may further include some of the pixels included in the inter-coded-area, in addition to the pixels included in the intra-coded-area.

When the encryption area is selected as described above, the encryption operation is selectively performed on the encryption area (S14). Encryption information indicating the area on which the encryption is performed may be generated, and the encrypted image generated by the compression and the encryption operations, and the encryption information are transmitted (S15). The encryption information included in the header information may be transmitted. For example, the encryption information may have a value indicating whether or not the encrypted image corresponding to the packet unit is encrypted.

Referring to FIG. 13, it is again assumed that a frame image may be compressed using an intra method and an inter method (S21). The encryption area may be selected with respect to the compressed image, and the encryption operation may be selectively performed with respect to the encryption area (S22).

The frame image may include a plurality of packet units, and the encrypted image may be transmitted in the packet unit. To generate information related to the selective encryption operation, whether the encryption is performed may be determined for each packet unit (S23). As described above, the packet unit may be defined by various methods. For example, any one line may include a plurality of packet units. If any one line (e.g., a first line) is encrypted as the intra-coded-area, it may be determined that the plurality of packet units included in the first line are encrypted.

The encryption information is generated according to the determination described above (S24). Then, a packet including the encrypted image and the encryption information may be generated (S25). The generated packet may be transmitted from the encoder to the decoder (S26).

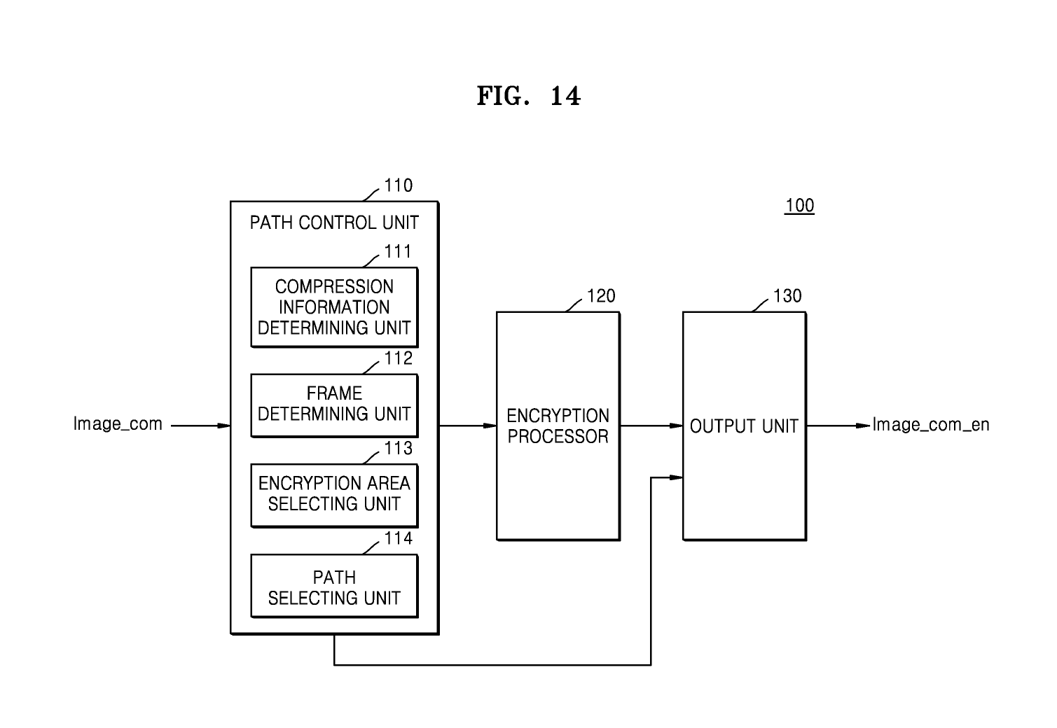

FIG. 14 is a block diagram of an encryption unit 100 included in an encoder according to exemplary embodiments. FIG. 14 illustrates an example in which an encryption area is selected by referring to characteristics of compressed frames.

As illustrated in FIG. 14, the encryption unit 100 may include a path control unit 110, an encryption processor 120, and an output unit 130. The path control unit 110 may include a compression information determining unit 111, a frame determining unit 112, an encryption area selecting unit 113, and a path selecting unit 114.

The path control unit 110 may receive a compressed image (Image_com) from a compression unit (not shown), and may selectively control application of an encryption operation with respect to the compressed image. For example, the compressed image in the form of a sequence of frame images may be provided to the path control unit 110, and the path control unit 110 may select an encryption area according to a frame unit. Alternately, the path control unit 110 may select an encryption area according to an area unit.

The compression information determining unit 111 may determine compression information with respect to each area (e.g., pixel, group of pixels, line, or block) in the frame image. For example, the compression information determining unit 111 may determine whether each area is an intra-coded-area or an inter-coded-area. As described above, the intra-coded-area and the inter-coded-area may be defined by various methods. The intra-coded-area may indicate an area that is compressed without referring to other areas, and with respect to at least some pixels of the intra-coded-area, original data may be provided as a compression result.

The compressed frame image may include information related to the types of frames, and the frame determining unit 112 may determine whether each frame is an intra frame or an inter frame, by referring to the information. The encryption area selecting unit 113 may select the encryption area based on a result of the determination of the compression information determining unit 111 and the frame determining unit 112. For example, the encryption area selecting unit 113 may select a frame image on which the encryption is to be performed, and a frame image on which the encryption is not to be performed, based on the result of the determination. The encryption area selecting unit 113 may select an area of the frame image, on which the encryption is to be performed, and an area of the frame image, on which the encryption is not to be performed, based on the result of the determination.

The path selecting unit 114 provides data of the area that is to be encrypted to the encryption processor 120, and directly provides data of the area that is not to be encrypted to the output unit 130, similarly to the above-described exemplary embodiments. The output unit 130 outputs an encrypted image (Image_com_en) on which the compression operation and the selective encryption operation are performed.

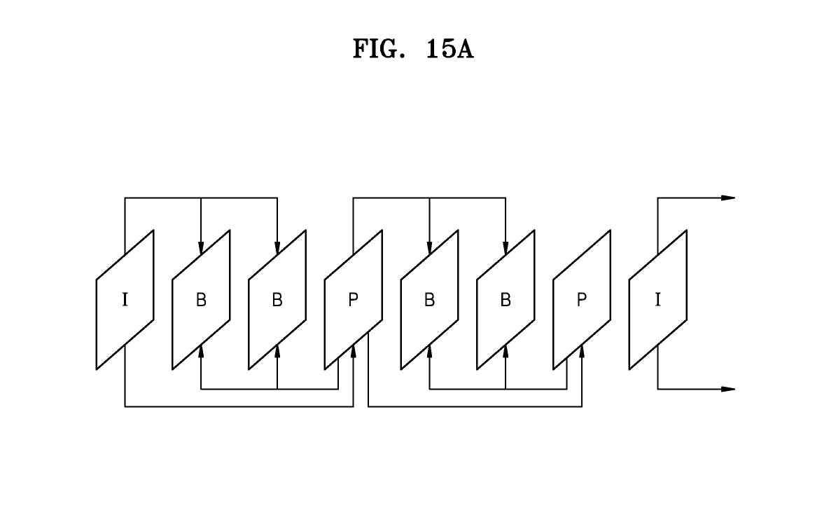

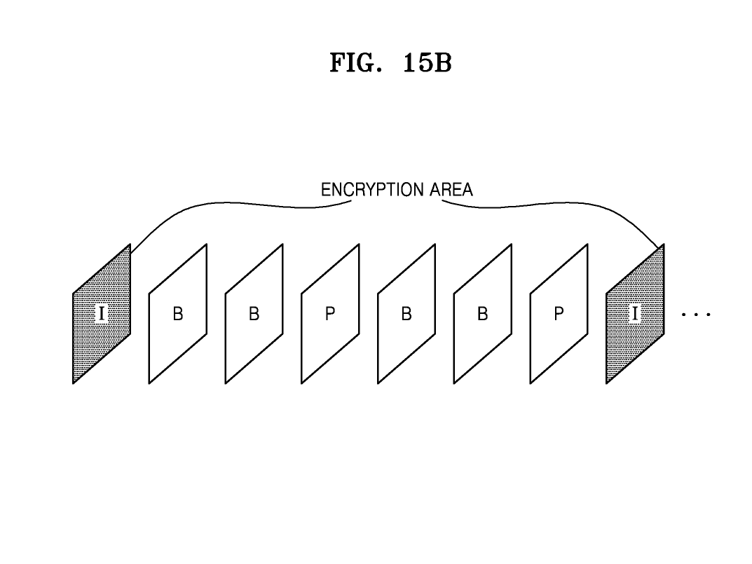

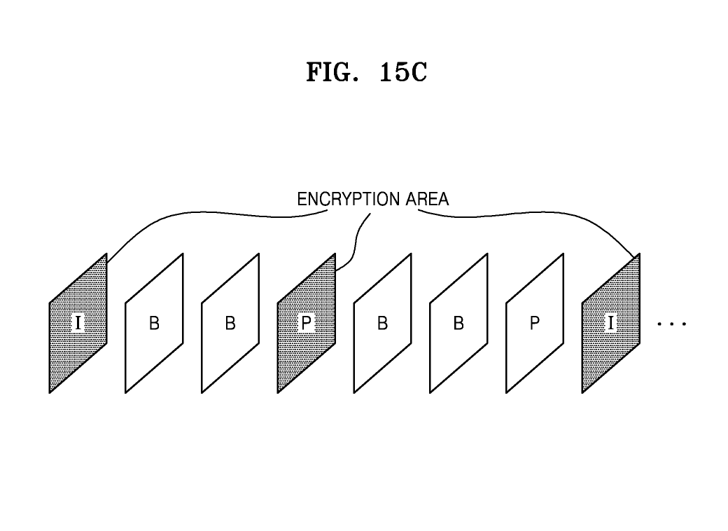

FIGS. 15A, 15B, and 15C are conceptual diagrams illustrating different types of frames that may be used during an image compression process.

As illustrated in FIG. 15A, a plurality of frame images may be sequentially compressed, and the plurality of frames divided into an I-type frame, a B-type frame, and a P-type frame. The I-type frame may be an intra frame, and may be compressed without referring to another frame. The B-type frame and the P-type frame may be inter frames, and may be compressed by referring to another frame. The P-type frame may be compressed by referring to an I-type frame or a P-type frame, and the B-type frame may be compressed by referring to an I-type frame, a P-type frame, or a B-type frame. Information indicating the type of each frame, as shown above, may be generated during the compression process and provided to the encryption unit 100 of FIG. 14.

As illustrated in FIGS. 15B and 15C, an encryption area may be selected with respect to a grouping of frame images. For example, an I-type frame may be a frame that is referred to by other frames, such as a P-type frame or a B-type frame, and only an I-type frame may be selected as the encryption area from among the grouping of frame images. That is, the encryption unit 100 of FIG. 14 may be used to selectively encrypt an I-type frame from among a grouping of frame images provided by a compression unit (not shown).

Alternatively, other types of frames may further be selected as an encryption area in addition to the I-type frame. For example, a P-type frame may be referred to by other types of frames (e.g., the B-type frame). According to an exemplary embodiment, only some frames may be selectively encrypted among a grouping of frame images. For example, an I-type frame or a P-type frame may be selected as the encryption area.

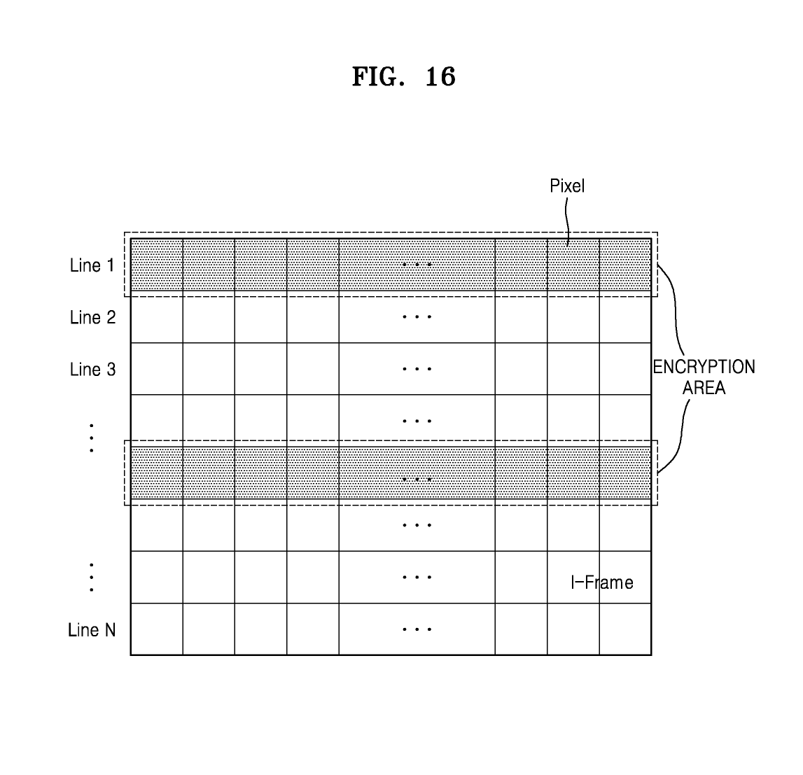

FIG. 16 is another conceptual diagram further illustrating certain exemplary embodiments in which only some areas of a frame image selected as the encryption area are encrypted. For example, it is assumed that an I-type frame has been selected for encryption from among a grouping of frame images. It is further assumed that only some areas of the selected I-type frame may be selectively encrypted.

Hence, similar to the above-described exemplary embodiments, the I-type frame may include a plurality of areas. For example, the I-type frame may include a plurality of lines (e.g., Line 1 to Line N). To select the encryption area, whether the encryption is to be performed for each line may be determined. For example, similarly to or substantially the same as the above-described exemplary embodiment, the intra coded line may be selected as the encryption area. Alternatively, only some of the pixels of the intra coded line may be encrypted, or some of the inter coded lines may further be encrypted, in addition to the intra coded line.

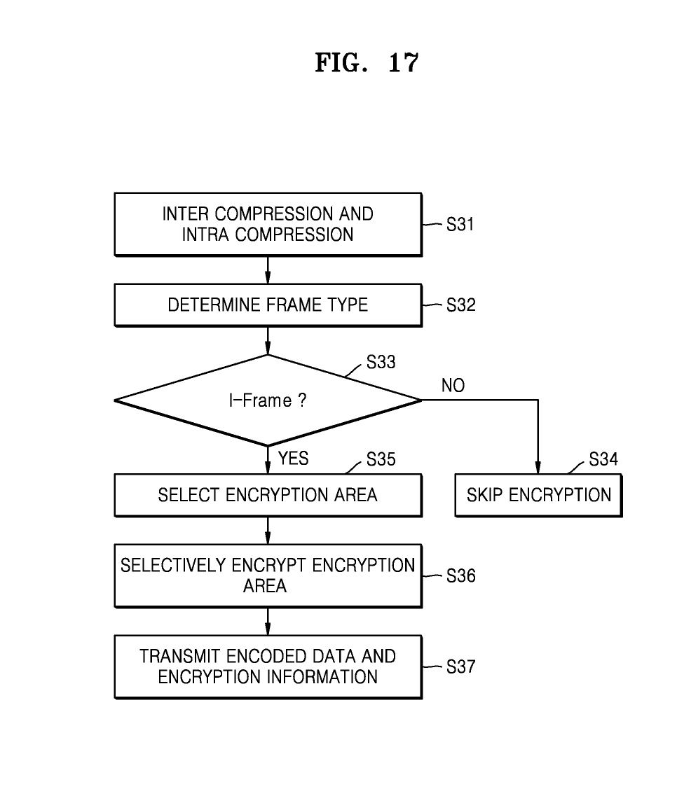

FIG. 17 is a flowchart summarizing an image processing method for the encoder including the encryption unit 100 of FIG. 14.

As illustrated in FIG. 17, each frame image may be compressed by an intra method or an inter method (S31) according to the above-described exemplary embodiments. Types of frames may be divided, according to a compression method applied to each frame image. The encryption unit 100 may determine the type of frames in order to perform selective encryption with respect to the frame images (S32).

The frame images may be divided into an I-type frame, a P-type frame, and a B-type frame. When it is assumed that only the I-type frame is selectively encrypted, the encryption unit 100 determines whether a frame image corresponds to the I-type frame (S33). If the frame image does not correspond to the I-type frame (S33=NO), as a result of the determination, the encryption operation is skipped on the frame image (S34).

However, when the frame image corresponds to the I-type frame (S33=YES), an encryption area is selected in the frame image (S35). The encryption area may be selected according to various methods, according to the above-described exemplary embodiments, and selective encryption is performed with respect to the encryption area (S36). A frame image that is compressed and encrypted may be transmitted as the encrypted image, and the encryption information related to the encryption operation may be transmitted (S37).

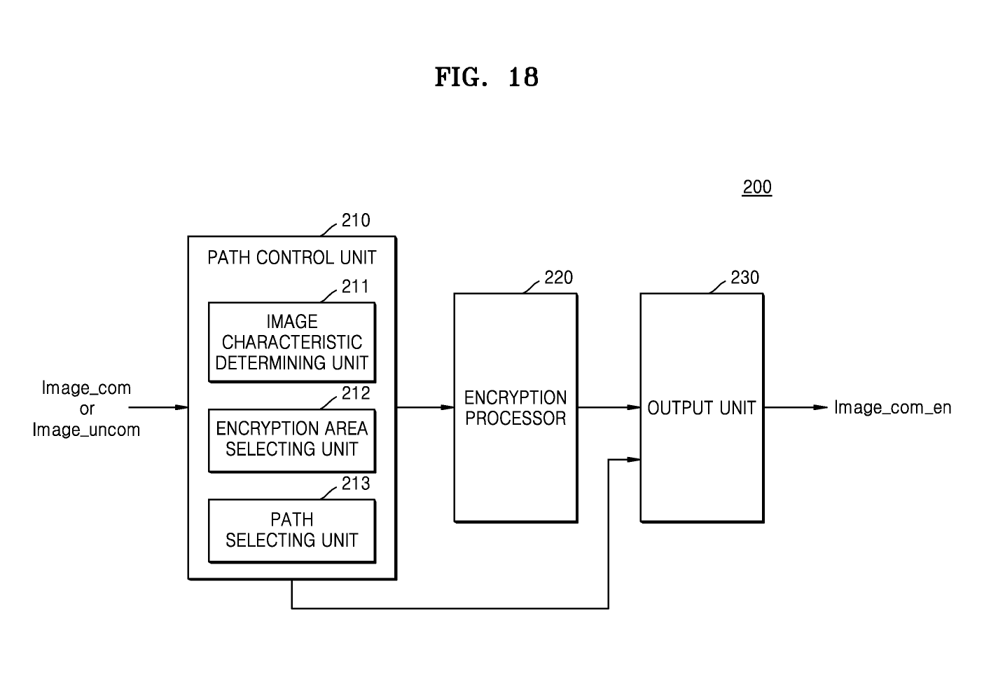

FIG. 18 is a block diagram illustrating an encryption unit 200 included in an encoder according to exemplary embodiments. FIG. 18 illustrates an example in which an encryption area is selected by referring to an image characteristic of a frame. Thus, the encryption unit 200 may selectively encrypt areas of a frame image that is compressed, or may selectively encrypt areas of a frame image that is not compressed.

As illustrated in FIG. 18, the encryption unit 200 may include a path control unit 210, an encryption processor 220, and an output unit 230. The path control unit 210 may include an image characteristic determining unit 211, an encryption area selecting unit 212, and a path selecting unit 213. An image provided to the encryption unit 200 may be a compressed image Image_com which is a compressed frame image, or the image provided to the encryption unit 200 may be an original image (Image_uncom) that is a non-compressed frame image.

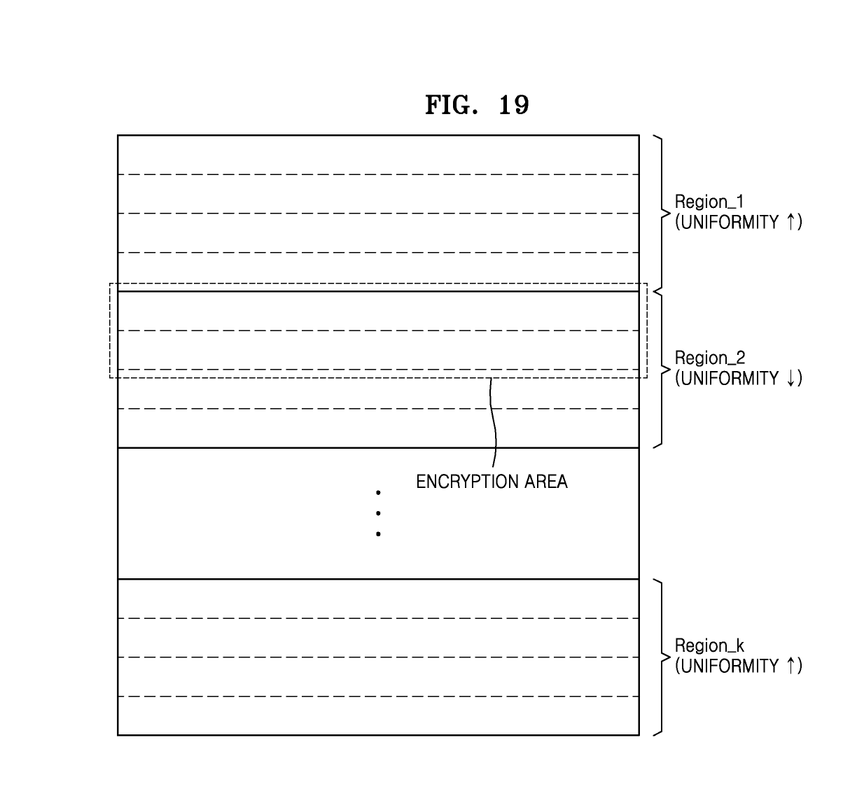

An example of an operation of the encryption unit 200 of FIG. 18 will be described with additional reference to the conceptual diagram of FIG. 19, where FIG. 19 illustrates an example in which an encryption area is selected in a frame image.

Various characteristics of a frame image may be determined by analyzing pixel values for pixels of the frame image. As an example of determining an image characteristic, the uniformity of an image may be analysed by calculating a deviation of pixels within the frame image. If the deviation of the pixels in a predetermined area of the frame image is relatively small, the area may be determined to be a uniform image. Alternately, if the deviation of the pixels in the predetermined area of the frame image is relatively large, the area may be determined to be a non-uniform image. For example, when the frame image has a black data region, the deviation of the pixels of the black data region will be small.

According to an exemplary embodiment, the image characteristic determining unit 211 may be used to determine a particular image characteristic for a frame image and generate a corresponding determination result. The determination of the image characteristic may be performed by the image characteristic determining unit 211. Alternatively, the determination of the image characteristic may be performed by some other functional block(s) of the encoder including the encryption unit 200. The characteristic information according to the determination of the image characteristic may be provided to the encryption unit 200. The image characteristic determining unit 211 may determine that one area of the frame image has high uniformity and another area of the frame image has low uniformity, by analyzing various pixels of the frame image or referring to externally provided characteristic information.

The encryption area selecting unit 212 may select an encryption area based on the determination of the image characteristic. For example, the encryption area selecting unit 212 may select the encryption area according to the uniformity of respective areas of the frame image. According to an exemplary embodiment, it may be assumed that there is one area of high uniformity and another area of low uniformity in a frame image, wherein each area includes a plurality of lines. Assuming a first region (Region_1) corresponds to a black data region, then Region_1 will exhibit a high uniformity. Thus, even if some of the lines of Region_1 are encrypted, pixel values for other lines may nonetheless be predicted. Hence, by referring to the uniformity of a particular area of the frame image, at least some lines of an area having relatively low uniformity (e.g., Region_2) should be selected as an encryption area.

For example, with respect to an area of the frame image exhibiting relatively low uniformity, the encryption area may be selected according to various methods. For example, when an original image (Image_uncom) is provided to the encryption unit 200, at least one of a plurality of lines of the Region_2 may be selected as the encryption area according to a predetermined pattern, or at least one of the plurality of lines of Region_2 may be randomly selected as the encryption area. For example, when a compressed image (Image_com) is provided to the encryption unit 200, the encryption area may selectively taking into account compression characteristics of the plurality of lines of Region_2. For example, some lines of Region_2 may be an intra-coded-area, and the intra-coded-area may be selected as the encryption area.

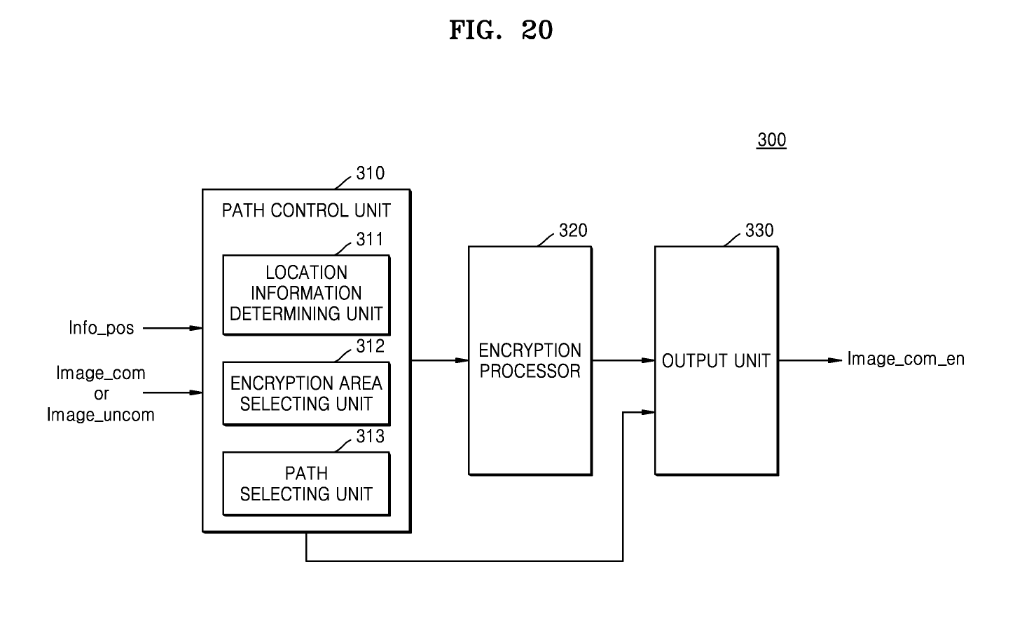

FIG. 20 is a block diagram illustrating an encryption unit 300 that may be included in an encoder according to exemplary embodiments. FIG. 20 illustrates an example in which an encryption area is selected by referring to a location of respective area(s) in a frame image. Here, the frame image provided to the encryption unit 300 may be a compressed image (Image_com) on which a compression operation has been performed, or it may be an original image (Image_uncom) on which a compression operation has not been performed.

As illustrated in FIG. 20, the encryption unit 300 may include a path control unit 310, an encryption processor 320, and an output unit 330. The path control unit 310 may include a location information analyzing unit 311, an encryption area selecting unit 312, and a path selecting unit 313.

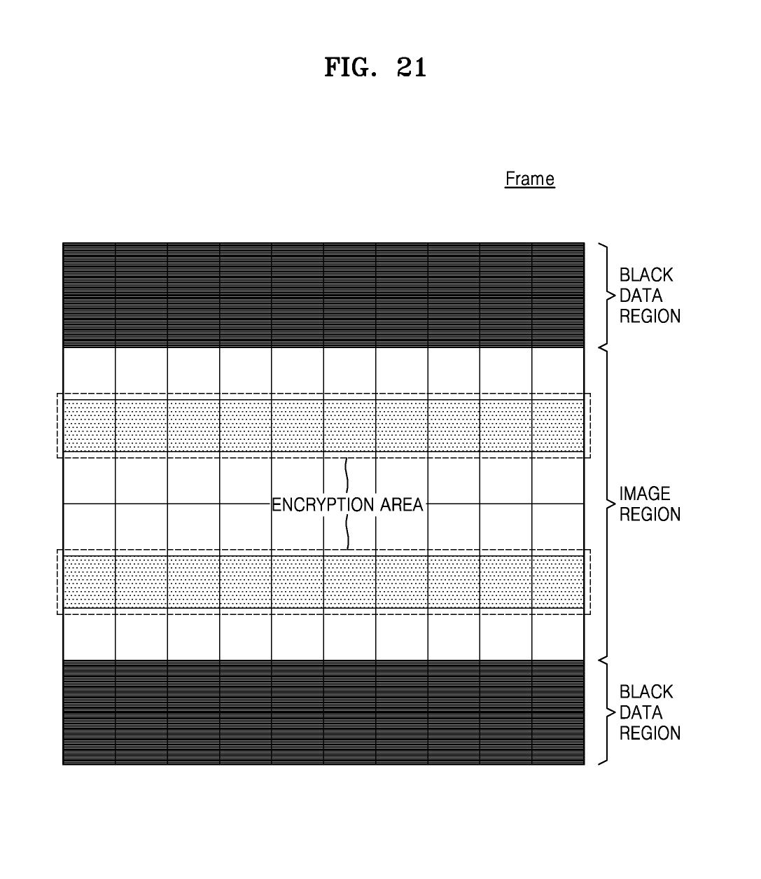

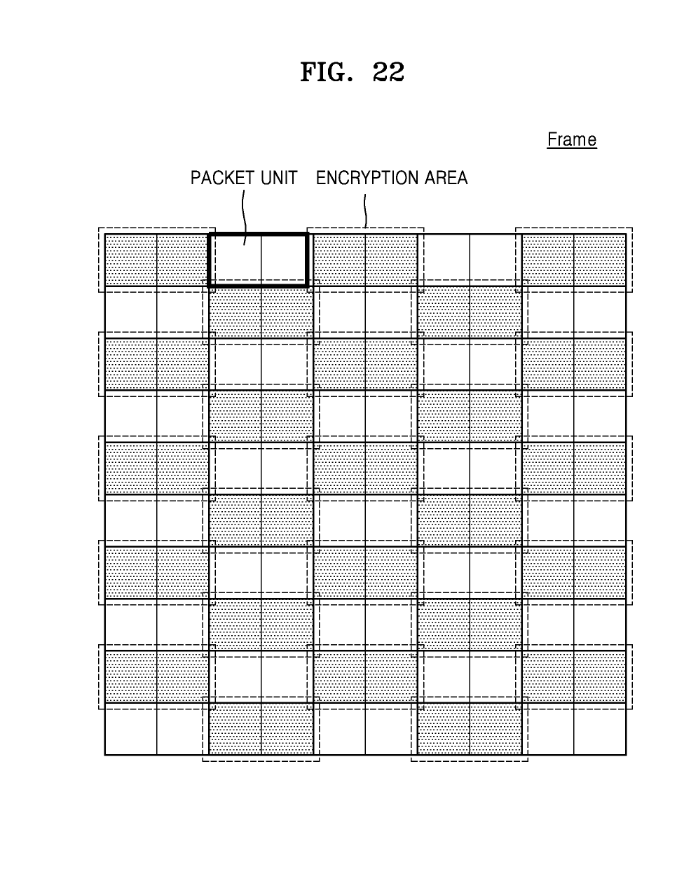

An example of an operation of the encryption unit 300 will be described with additional reference to FIGS. 21 and 22.

The encryption unit 300 may receive location information (Info_pos) with respect to a pixel or an area included in the frame image. The encryption unit 300 may then determine a location of the pixel or the area in the frame image by referring to the location information.

According to the exemplary embodiments, the encryption area on which the encryption is to be performed may be selected in the frame image. For example, regardless of a compression method or an image characteristic of the frame image, only some areas of the frame image may be selectively encrypted. The location of an area corresponding to an encryption area may be analyzed by referring to the location information. Data of the encryption area may be provided to the output unit 330 via the encryption processor 320, and data not corresponding to the encryption area may be directly provided to the output unit 330 without passing through the encryption processor 320.

Referring to FIG. 21, a predictable area, such as a black data region, may be included in the frame image, and the encryption area may be distributed in order to prevent the encryption of only the predictable area. For example, a location of the encryption area may be pre-determined in one frame image, and the information related to the location of the encryption area may be stored in the encryption unit 300. Whether each area corresponds to the encryption area may be determined by referring to the location information.

Referring to FIG. 21, the black data region may be located in an upper portion and a bottom portion of the frame image, and an image region in which an actual image is output may be located between the black data regions. According to an exemplary embodiment, the encryption area may be distributed in a line unit, and thus, at least one line of the area in which the actual image is output may be selectively encrypted.

Referring to FIG. 22, one frame image may include a plurality of packet units, and the encryption area may be distributed in the packet unit according to an exemplary embodiment. That is, some packet units on which the encryption is performed may be pre-set according to a predetermined pattern with respect to the plurality of packet units. Whether an area corresponding to each packet unit corresponds to the encryption area may be determined by referring to the location information.

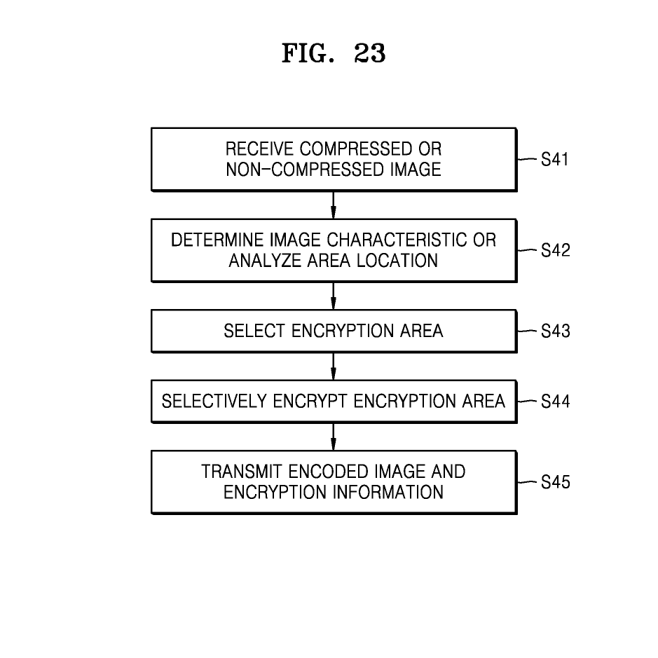

FIG. 23 is a flowchart summarizing an image processing method for an encoder including the encryption units 200 and 300 of FIGS. 18 and 20.

As illustrated in FIG. 23, the encryption units 200 and 300 may receive a compressed image on which a compression operation is performed, or an original image on which the compression operation is not performed (S41). The encryption units 200 and 300 may further receive location information indicating a location for predetermined areas in a frame image. The encryption units 200 and 300 may then determine an image characteristic for the frame image or analyze locations of the predetermined areas in the frame image (S42).

The encryption units 200 and 300 may select an encryption area based on the determination of the image characteristic or the analysis of the locations of the areas in the frame image (S43). Similarly to or substantially the same as the above-described exemplary embodiments, the encryption area may be selected such that encryption is performed on areas other than a predictable area, by determining a uniformity of the frame image, or such that areas on which the encryption is performed are distributed according to a predetermined pattern. Then, the encryption area may be selectively encrypted (S44) and an encrypted image and encryption information related to the encryption operation may be transmitted in (S45).

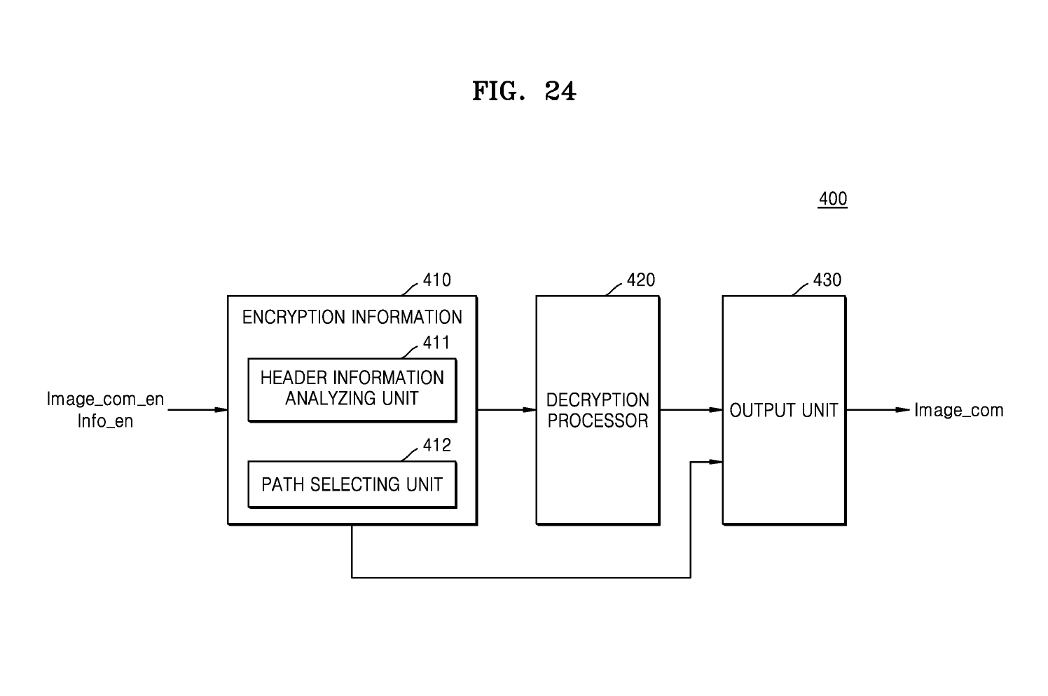

FIG. 24 is a block diagram illustrating a decryption unit 400 that may be included in a decoder according to an exemplary embodiment.

As illustrated in FIG. 24, the decryption unit 400 may include a path control unit 410, a decryption processor 420, and an output unit 430. The path control unit 410 may include a header information analyzing unit 411 and a path selecting unit 412.

The decryption unit 400 may receive an encrypted image and header information extracted from an interface device of the decoder. The header information may include the encryption information (Info_en). The header information analyzing unit 411 may analyze the encryption information and provide a result of the analysis to the path selecting unit 412.

The path selecting unit 412 may control a plurality of areas included in the encrypted image (Image_com_en) such that some predetermined areas of the plurality of areas are selectively decrypted in response to the encryption information. For example, when the encryption information corresponding to a first area has a first value, the path selecting unit 412 provides data for the first area to the decryption processor 420. However, when the encryption information corresponding to a second area has a second value materially different from the first value, a decryption process may not be performed on data for the area, and instead, the data may be directly provided to the output unit 430. The output unit 430 may output an image generated by decrypting the encryption area (e.g., the compression image—(Image_com)), and then, an original image may be generated by decompressing the compression image (Image_com).

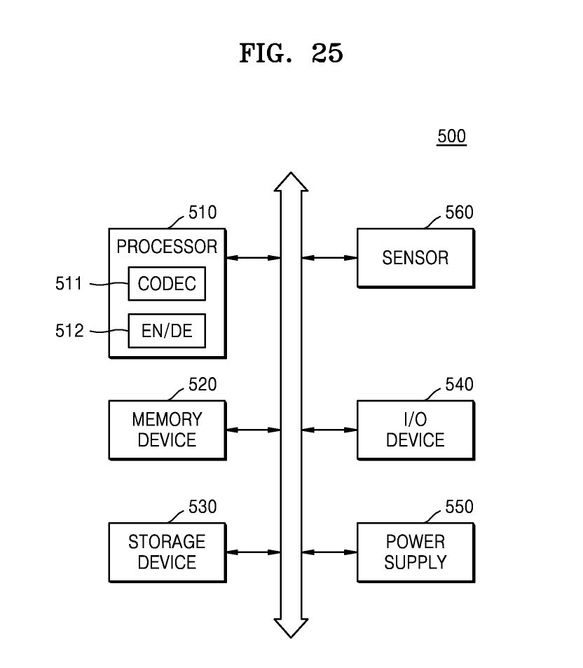

FIG. 25 is a block diagram illustrating a computing system 500 that may include an image processing device according to an exemplary embodiment.

Referring to FIG. 25, the computing system 500 may include a processor 510, a memory device 520, a storage device 530, an input/output device 540, a power supply 550, and an image sensor 560. Although not illustrated in FIG. 25, the computing system 500 may further include ports which may communicate with a video card, a sound card, a memory card, a USB device, or other electronic devices.

The processor 510 may be an application processor embodied as a system on chip (SoC). The processor 510 may perform specific calculations or tasks. According to an exemplary embodiment, the processor 510 may include a micro-processor or a central processing unit (CPU). The processor 510 may perform communication with the memory device 520, the storage device 530, and the input/output device 540, via an address bus, a control bus, and a data bus.

According to an exemplary embodiment, the processor 510 may be connected to an expansion bus, such as a peripheral component interconnect (PCI) bus. The memory device 520 may store data necessary for an operation of the computing system 500. For example, the memory device 520 may be embodied as dynamic random access memory (DRAM), mobile DRAM, static random-access memory (SRAM), a flash memory, phase change RAM (PRAM), ferroelectric (FRAM), resistive RAM (RRAM), and/or magnetic RAM (MRAM).

The storage device 530 may include, for example, a solid state drive (SSD), a hard disk drive (HDD), or CD-ROM. The input/output device 540 may include an input device, such as a keyboard, a keypad, a mouse, etc., and an output device, such as a printer, a display, etc. The power supply 550 may supply an operation voltage necessary for an operation of the computing system 500.

The image sensor 560 may perform communication, in connection with the processor 510, via the buses or other communication links. The image sensor 560 may be integrated into one chip, together with the processor 510, or the image sensor 560 and the processor 510 may be integrated into different chips.

A function of performing the compression operation according to the exemplary embodiments may be performed by a codec module 511 of the processor 510, and a function of performing the selective encryption operation may be performed by an encryption/decryption module 512 of the processor 510. For example, the codec module 511 may compress an image according to an intra method or an inter method. Also, when an image is provided to the outside of the computing system 500, the encryption/decryption module 512 may encrypt the image or an image compressed by the codec module 511. Here, the encryption/decryption module 512 may select some areas of the image as an encryption area and may selectively encrypt the encryption area, according to the exemplary embodiments.

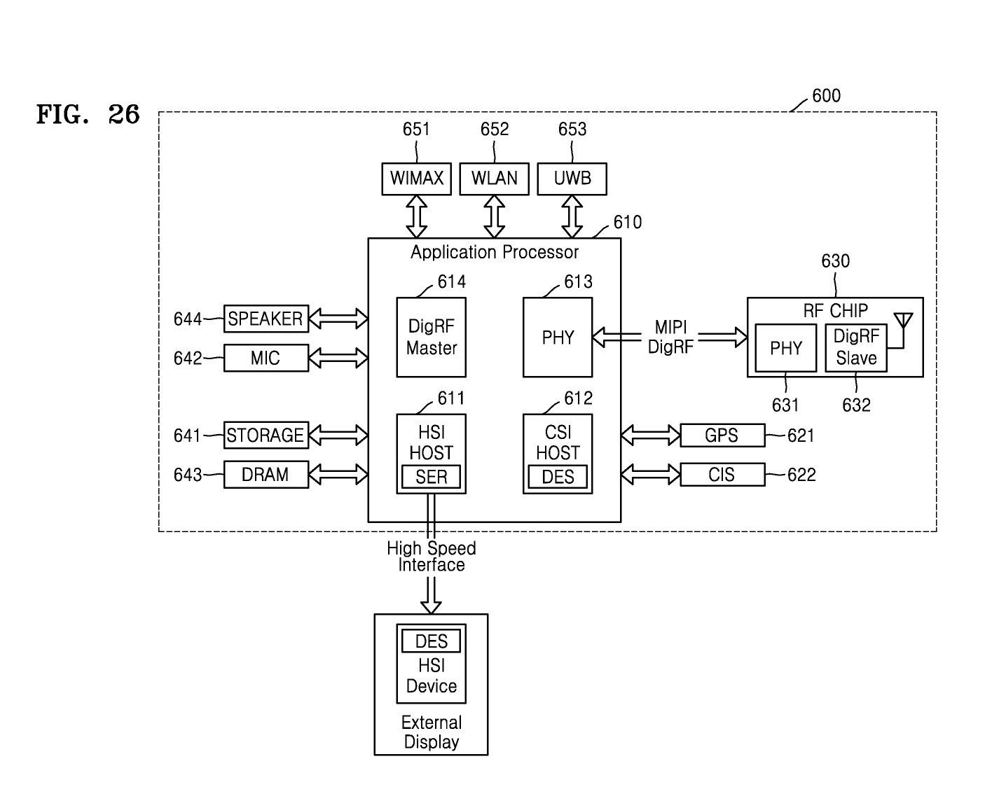

FIG. 26 is a block diagram illustrating an interface that may be used in a computing system 600 similar to the one illustrated in FIG. 25.

Referring to FIG. 26, the computing system 600 may be embodied as a data processing device which may use or support a mobile industry processor interface (MIPI). The computing system 600 may include an application processor (AP) 610.

A camera serial interface (CSI) host 612 of the AP 610 may perform serial communication with an image sensor (CIS) 622 via a CSI. According to an exemplary embodiment, the CSI host 612 may include a deserializer (DES), and the image sensor 622 may include a serializer (SER).

Meanwhile, a high speed interface (HSI) host 611 of the AP 610 may perform communication with an HSI device of an external display device, via an HSI. According to an exemplary embodiment, the HSI host 611 may include an SER, and the HSI device may include a DES. According to the exemplary embodiments, since the compression and the selective encryption are performed with respect to an image provided to the outside of the computing system 600, a speed of data transmission between the HSI host 611 and the external HSI device may be increased.

The computing system 600 may further include a radio frequency (RF) chip 630 which may perform communication with the AP 610. The RF chip 630 includes a physical layer (PHY) 631 and a DigRF slave 632.

The PHY 613 of the AP 610 and a PHY 631 of the RF chip 630 may transmit and receive data according to a MIPI DigRF. The AP 610 may further include a DigRF master 614 for controlling data transmission and reception according to the MIPI DigRF of the PHY 613.

The computing system 600 may further include a global positioning system (GPS) 621, a storage 641, a microphone 642, DRAM 643, and a speaker 644. Also, the computing system 600 may perform communication by using, for example, an ultra wideband (UWB) 653, a wireless local area network (WLAN) 652, and a worldwide interoperability for microwave access (WIMAX) 651. However, the structure and the interface of the computing system 600 are only exemplary, and the computing system 600 is not limited thereto.

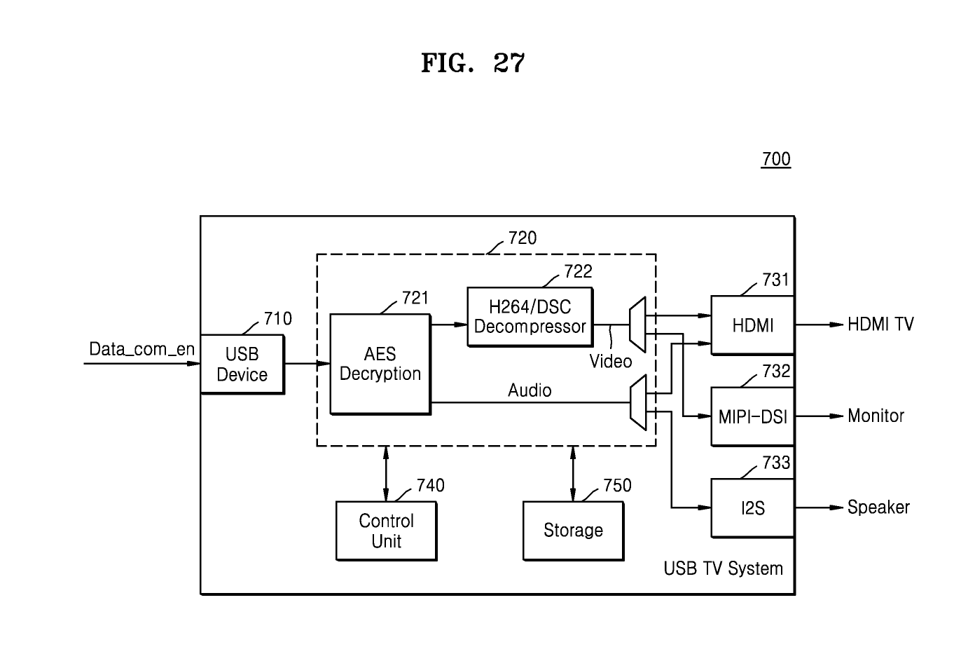

FIG. 27 is a block diagram illustrating an example of a universal serial bus (USB) TV system 700 in which an image processing method according to exemplary embodiments may be applied.

As illustrated in FIG. 27, the USB TV system 700 may receive data (Data_com_en) that is encoded according to the exemplary embodiments. The encoded data may include encoded audio information and encrypted image information. The encoded audio information may be an encrypted audio. The encrypted image information may be data generated by performing compression on a frame image, and performing selective encryption on the compressed image, according to the exemplary embodiments. The USB TV system 700 may receive and store the encoded data. The USB TV system 700 may perform decryption and decompression operations with respect to the stored encoded data Data_com_en to provide an original image, together with an audio signal.

The USB TV system 700 may be embodied to perform various functions. For example, when the USB TV system 700 may receive and store the encoded data, the USB TV system 700 may store the encoded data Data_com_en without decryption and decompression operations. Thus, the information stored in the USB TV system 700 may be data, the security of which is maintained. Also, the USB TV system 700 may provide an image signal and an audio signal to an image/audio output device by being connected to the image/audio output device. To this end, the selective decryption and the decompression according to the exemplary embodiments may be performed in the USB TV system 700.

For example, the USB TV system 700 may include a USB device 710, an image processing device 720, and one or more output ports 731, 732, and 733. The USB TV system 700 may further include a control unit 740 and a storage 750 for generally controlling the system.

The USB device 710 may transmit and receive data according to a USB protocol. FIG. 27 illustrates the process in which the USB TV system 700 receives the encoded data. However, the USB TV system 700 may provide the encoded data to an external device or system via the USB device 710. The image processing device 720 may include an AES decryption unit 721, a decompressor 722, and one or more path selectors, for the selective decryption and decompression operations according to the exemplary embodiments. According to the exemplary embodiments, only some areas of a frame image may be selectively encrypted based on various information of a compressed image. For example, the AES decryption unit 721 selectively decrypts only some areas of the frame image, based on the encryption information included in the encoded data. The decompressor 722 may generate an original image by performing a decompressing process on the decrypted compressed image. According to an exemplary embodiment, audio data included in the encoded data may also be encrypted. Accordingly, the AES decryption unit 721 may generate an audio signal by decrypting the audio data.

The one or more output ports 731, 732, and 733 may be connected to external devices (for example, an HDMI TV, an MIPI-DSI display device, a speaker, etc.) according to various protocols. For example, the HDMI port 731, which is one of the output ports, may be connected to the HDMI TV and may output the decoded image and the audio signal. The MIPI-DSI port 732 may output the decoded image according to the MIPI-DSI standards, and the I2S port 733 may output an audio signal according to an I2S interface method. As in the above-described exemplary embodiments, information stored in the storage 750 may be set in various methods. For example, data that is encrypted and compressed may be stored, compressed data after the decryption is performed may be stored, or an original image on which both the decryption and the decompression are performed may be stored.

While the inventive concept has been particularly shown and described with reference to exemplary embodiments thereof, it will be understood that various changes in form and details may be made therein without departing from the scope of the following claims.

1. An image processing method comprising:
compressing an image including a plurality of areas using a compression operation;
selectively encrypting a first area among the plurality of areas to generate an encrypted image;
generating encryption information indicating the first area among the plurality of areas; and
communicating the encrypted image and the encryption information.

2. The image processing method of claim 1, further comprising:
designating the first area as an encryption area based on the compression operation; and
designating a second area among the plurality of areas as a non-encryption area.

3. The image processing method of claim 2, wherein the encryption area is an intra-coded-area and the non-encryption are is aa inter-coded-area.

4. The image processing method of claim 1, wherein the image includes a plurality of lines, and the selective encryption of the first area includes encrypting at least one of the plurality of lines and not encrypting at least another one of the plurality of lines.

5. The image processing method of claim 1, wherein the image includes a plurality of lines including a first line, the first line including a first pixel and a second pixel, and the selective encryption of the first area includes encrypting the first pixel and not encrypting the second pixel.

6. The image processing method of claim 1, wherein the image includes a plurality of macro-blocks, and the selective encryption of the first area includes encrypting at least one of the plurality of macro-blocks and not encrypting at least another one of the plurality of macro-blocks.

7. The image processing method of claim 1, wherein the image includes a plurality of frame images, and the selective encryption of the first area includes encrypting at least one of the plurality of frame images and not encrypting at least another one of the plurality of frame images.

8. The image processing method of claim 1, wherein the image is a frame image including a plurality of slices, each one of the plurality of slices including a plurality of lines, and the selective encryption of the first area includes encrypting at least one of the plurality of lines of one of the plurality of slices and not encrypting at least another one of the plurality of lines of the one of the plurality of slices.

9. The image processing method of claim 1, wherein the encrypted image and the encryption information are configured in a packet prior to communication.

10. The image processing method of claim 9, wherein the packet includes header information including the encryption information.

11. The image processing method of claim 1, wherein the plurality of areas includes a first set of areas and a second set of areas,
the compressing of the image including the plurality of areas using the compression operation includes compressing the first set of areas but not compressing the second set of areas, and
the selective encryption of the first area includes selectively encrypting the second set of areas.

12-20. (canceled)

21. An image processing method comprising:
selectively encrypting a first area of a frame image;
transmitting a first packet, the first packet comprising an encrypted image of the first area and encryption information having a first value indicating that the first area is encrypted; and
transmitting a second packet, the second packet comprising a non-encrypted image of a second area of the frame image and encryption information having a second value indicating that the second area is not encrypted.

22. The image processing method of claim 21, wherein information indicating a location of an encryption area in the frame image is pre-set, and the method further comprises:
determining whether areas of the frame image are in the encryption area, wherein based on the determination, areas located in the encryption area are selectively encrypted.

23. The image processing method of claim 21, further comprising:
compressing the frame image, wherein the first area is an intra-coded-area and the second area is an inter-coded-area.

24. The image processing method of claim 19, wherein the frame image comprises ‘n’ areas, where ‘n’ is an integer at least equal to 3, and
at least one of the ‘n’ areas is encrypted, and another one of the n areas is not encrypted.

25. An image processing device comprising:
a compression unit that compresses an image including a plurality of areas using a compression operation to generate a compressed image;
an encryption unit that selectively encrypts at least one of the plurality of areas using an encryption operation; and
an interface host that communicates an encrypted image and encryption information corresponding to the encrypted image, wherein the encrypted image is generated from the compressed image using the encryption operation.

26. The image processing device of claim 25, wherein the interface host generates and communicates a packet including the encrypted image and encryption information.

27. The image processing device of claim 25, wherein the plurality of areas includes at one intra-coded area and at least one inter-coded-area, and the encryption unit comprises:
an encryption area selecting unit determining a compression characteristic for each one of the plurality of areas and selecting the at least one of the plurality of areas as encryption areas based on the at one intra-coded area and the at least one inter-coded-area;
a path control unit controlling transmission paths for data of areas corresponding to the encryption areas and data for areas not corresponding to the encryption areas; and
an encryption processor selectively encrypting the data of the areas corresponding to the encryption areas.

28. A universal serial bus (USB) TV system comprising:
a USB device configured to receive encoded data via a USB protocol;
an image processing device configured to process the encoded data received via the USB device; and
at least one port configured to output an original image generated via the image processing device, according to at least one interface,
wherein an encrypted image comprised in the encoded data is an image in which only some of a plurality of areas are selectively encrypted, and
the image processing device selectively decrypts the plurality of areas of the encrypted image, by referring to at least one piece of information comprised in the encoded data.

29. The USB TV system of claim 26, further comprising a storage device for storing the encoded data on which operations for decompression and decryption are not performed,
wherein when the USB TV system outputs data, the encoded data, which is stored on the storage device is output to the outside.

30-40. (canceled)
